(19) United States
(12) Patent Application Publication
(10) Pub. No.: US 2020/0202198 A1
(43) Pub. Date: Jun. 25, 2020

(54) NEURAL NETWORK PROCESSOR

(71) Applicant: Waymo LLC, Mountain View, CA (US)

(72) Inventors: Kyong Ho Lee, San Jose, CA (US); Sabareeshkumar Ravikumar, Sunnyvale, CA (US); Paul Donnelly, San Jose, CA (US); Daniel Rosenband, San Jose, VA (US)

(21) Appl. No.: 16/230,740

(22) Filed: Dec. 21, 2018

(51) Int. Cl. G06N 3/063; G06N 3/04; G06N 3/08

(52) U.S. Cl. CPC G06N 3/063; G06N 3/08; G06N 3/04

(57) ABSTRACT

A circuit for performing computations for a neural network comprising multiple neural network (NN) layers. The circuit includes a processing device that provides programming data for performing the computations and a core in data communication with the processing device to receive the programming data. The core includes activation memory that stores inputs for a layer and parameter memory that stores parameters for a first NN layer. The core also includes a rotation unit that rotates accessing the inputs from the activation memory based on the programming data and a computation unit that receives a respective input and a parameter for the first NN layer and generates an output of the first NN layer using the input and the parameter. The core also includes a crossbar unit that causes the output to be stored, in the activation memory, in accordance with a bank assignment pattern.

### BACKGROUND

This specification relates to computing neural network inferences in hardware.

Neural networks are machine learning models that employ one or more layers of nodes to generate an output, e.g., a classification, for a received input. Some neural networks include one or more hidden layers in addition to an output layer. The output of each hidden layer is used as input to one or more other layers in the network, e.g., other hidden layers or the output layer of the network. Some of the layers of the network generate an output from a received input in accordance with current values of a respective set of parameters.

Some neural networks include one or more convolutional neural network layers. Each convolutional neural network layer has an associated set of kernels. Kernels can be represented as a tensor, i.e., a multi-dimensional array, of parameters. Each convolutional layer can also process a set of activation inputs. The set of activation inputs can also be represented as a tensor.

### SUMMARY

This specification describes a special-purpose hardware circuit that performs neural network computations. The hardware circuit includes a core that interacts with components of the circuit to accelerate computations for a neural network workload. The core includes control logic and multiple components that may be implemented in hardware or software. The control logic is used to provide instructions for a neural network computation to each of the multiple components in the core. The core includes an activation memory that stores inputs, input activations, or outputs, output activations, and a parameter memory that stores sets of parameters for at least part of one layer of a neural network, e.g., a convolutional neural network (CNN). The core also includes a computation unit, a rotation unit, and a crossbar unit.

The computation unit is used to perform the neural network computations for processing an input through a layer of the neural network. For example, the computation unit processes the input activations from the activation memory and parameters from the parameter memory to generate a set of outputs for a layer. The rotation unit obtains inputs from the activation memory and provides the inputs to computing cells of the computation unit. The rotation unit obtains the inputs from the activation memory and routes the inputs to the computation unit in a manner that optimizes overall usage of the computing cells. The crossbar unit uses bank assignment patterns to store the outputs for the layer in the activation memory. The crossbar unit stores the outputs such that the activation memory does not experience bank conflict when the stored outputs are obtained as inputs to a subsequent layer.

The hardware circuit further includes a kernel location memory that may be implemented at the core. The kernel location memory stores parameter indices and other data representing kernel structures. The kernel structures can correspond to the sets of parameters for a layer of the neural network. The core uses the kernel location memory to more efficiently process kernel structures with different sparseness attributes, e.g., an arrangement of zero and non-zero values in the kernel structure. The core interacts with the kernel location memory to support arbitrary kernel shapes, such as kernels that have an arbitrary arrangement of zero and non-zero values over different spatial dimensions of the kernel structure.

The hardware circuit is configured to leverage parallelism in depthwise convolutions with improved efficiency over conventional circuits. Using the core and other components of the hardware circuit, opportunities for exploiting parallelism are leveraged to accelerate performing not only depthwise convolutions, but also dense convolutions. For example, in a dense convolution, the hardware circuit can support a certain number of input channels (zin) and output channels (zout) for a set of activations based on a quantity of computing cells that are available at the computation unit.

In depthwise convolutions, an input channel can be used to generate multiple output channels, e.g., a single input channel can be used to generate 1 output channel, 2 output channels, or 4 output channels. The hardware circuit employs configurable logic that uses the rotation unit and crossbar unit to execute different kx and ky parallelisms (e.g., parallel computations where multiple products using parameters in x and y directions are computed in the same cycle) features of the circuit. These features relate to a number of output channels that are generated from a single input channel. The configurable logic enables the hardware circuit to improve computing efficiency for depthwise convolutions by increasing overall usage of the computation unit during depthwise convolutions.

One aspect of the subject matter described in this specification can be embodied in a circuit for performing computations for a neural network including multiple neural network layers. The circuit includes: a processing device configured to process data signals and provide programming data for performing the computations; and a core in data communication with the processing device to receive the programming data provided by the processing device. The core includes: an activation memory configured to store sets of layer inputs; a parameter memory configured to store parameters for a first neural network layer; a rotation unit configured to rotate accessing the sets of layer inputs from the activation memory based on the programming data; and a computation unit having multiple computing cells.

At least one computing cell of the multiple computing cells is configured to: i) receive, for the first neural network layer, an input of the sets of layer inputs accessed by the rotation unit, ii) receive a parameter for the first neural network layer, and iii) generate at least a portion of an output of the first neural network layer using the input and the parameter. The core further includes a crossbar unit configured to cause the output of the first neural network layer to be stored, in the activation memory, in accordance with a bank assignment pattern that is based on the programming data and an attribute value assigned to a second neural network layer.

These and other implementations can each optionally include one or more of the following features. For example, in some implementations, the rotation unit is further configured to rotate elements of an input tensor, where each element of the input tensor corresponds to a respective input of a set of inputs stored in the activation memory.

In some implementations, the rotation unit is further configured to: rotate elements of the input tensor along a first dimension of the input tensor based on a first rotation factor; rotate elements of the input tensor along a different second dimension of the input tensor based on a second rotation factor that is different than the first rotation factor; and provide an input that corresponds to a rotated element of the input tensor to a computing cell of the computation unit.

In some implementations, the crossbar unit is further configured to: determine a mapping of activations in the output in response to processing the bank assignment pattern, where the mapping identifies memory banks of the activation memory for storing the activations for the second neural network layer based on the attribute value assigned to the second neural network layer. In some implementations, the crossbar unit is further configured to: cause data for the output of the first neural network layer to be stored at particular address locations of the activation memory, the data for the output being assigned to an address location of the activation memory based on a configurable mapping that changes for different respective layers of the neural network.

In some implementations, the rotation unit is further configured to access output data for the output of the first neural network layer as layer inputs to the second neural network layer for processing at the second neural network layer; and the determined mapping is configured such that a bank conflict does not occur at the memory banks of the activation memory when the rotation unit accesses layer inputs for the second neural network layer that correspond to the output of the first neural network layer.

In some implementations, the attribute value assigned to the second neural network layer is: a stride value for the second neural network layer, or a skip value for the second neural network layer. In some implementations, the core is configured to: use the rotation unit to access layer inputs stored in a first set of memory banks of the activation memory without the occurrence of a bank conflict; and use the crossbar unit to store layer outputs in a second set of memory banks of the activation memory without the occurrence of a bank conflict.

In some implementations, the core is configured to: synchronize rotation based data access operations of the rotation unit with pattern based data storage operations of the crossbar unit to achieve a utilization rate of the computation unit that exceeds a threshold utilization rate. In some implementations the processing device is configured to: receive, from an external controller, an instruction including data values to be used at the core; and provide at least the data values of the instruction to the core for storing at a component of the core.

In some implementations, the processing device is a digital signal processor (DSP) configured to: process an instruction received from the external controller; and in response to processing the instruction, configure one or more registers at the core using data values of the instruction. In some implementations, the core is configured to access the one or more registers to obtain configuration data that defines the computations for the neural network, the computations being performed by the computation unit of the core based on data values derived from the instructions received from the external controller.

One aspect of the subject matter described in this specification can be embodied in a computer-implemented method for performing computations for a neural network including multiple neural network layers. The method includes: providing, by a processing device of a hardware circuit, programming data for performing the computations for the neural network; receiving, by a core of the hardware circuit that communicates with the processing device, the programming data provided by the processing device, wherein the core includes an activation memory configured to store sets of layer inputs and a parameter memory configured to store parameters for a first neural network layer; and accessing, by a rotation unit of the core, the sets of layer inputs stored at the activation memory, wherein the rotation unit rotates accessing the sets of layer inputs based on the programming data received by the core.

The method further includes, receiving, by a computation unit of the core, an input of the sets of layer inputs accessed by the rotation unit, the input being received for processing at the first neural network layer; receiving, by the computation unit, a parameter for the first neural network layer; generating, by the computation unit, an output of the first neural network layer using the input accessed by the rotation unit and the parameter; and storing, using a crossbar unit of the core, the output of the first neural network layer in the activation memory in accordance with a bank assignment pattern that is based on the programming data and an attribute value assigned to a second neural network layer.

These and other implementations can each optionally include one or more of the following features. For example, in some implementations, the method further includes: rotating, by the rotation unit, elements of an input tensor, where each element of the input tensor corresponds to a respective input of a set of inputs stored in the activation memory.

In some implementations, the method further includes: rotating, by the rotation unit, elements of the input tensor along a first dimension of the input tensor based on a first rotation factor; rotating, by the rotation unit, elements of the input tensor along a different second dimension of the input tensor based on a second rotation factor that is different than the first rotation factor; and providing, by the rotation unit, an input that corresponds to a rotated element of the input tensor to a computing cell of the computation unit.

In some implementations, the method further includes: determining, by the crossbar unit, a mapping of activations in the output in response to processing the bank assignment pattern, where the mapping identifies memory banks of the activation memory for storing the activations for the second neural network layer based on the attribute value assigned to the second neural network layer.

In some implementations, the method further includes: assigning, using the crossbar unit, data for the output of the first neural network layer to an address location of the activation memory based on a configurable mapping that changes for different respective layers of the neural network; and storing, using the crossbar unit, the data for the output of the first neural network layer at particular assigned address locations of the activation memory based on the configurable mapping for the second neural network layer.

In some implementations, the rotation unit is further configured to access output data for the output of the first neural network layer as layer inputs to the second neural network layer for processing at the second neural network layer; and the determined mapping is configured such that a bank conflict does not occur at the memory banks of the activation memory when the rotation unit accesses layer inputs for the second neural network layer that correspond to the output of the first neural network layer.

In some implementations, the method further includes: assigning a stride value for the second neural network layer that corresponds to the attribute value; or assigning a skip value for the second neural network layer that corresponds to the attribute value. In some implementations, the method further includes: using, by the core, the rotation unit to access layer inputs stored in a first set of memory banks of the activation memory without the occurrence of a bank conflict; and using, by the core, the crossbar unit to store layer outputs in a second set of memory banks of the activation memory without the occurrence of a bank conflict.

In some implementations, the method further includes: synchronizing, by the core, rotation based data access operations of the rotation unit with pattern based data storage operations of the crossbar unit to achieve a utilization rate of the computation unit that exceeds a threshold utilization rate. In some implementations, the method further includes: receiving, by the processing device and from an external controller, an instruction including data values to be used at the core; and providing, by the processing device, at least the data values of the instruction to the core for storing at a component of the core.

In some implementations, the processing device is a digital signal processor (DSP) and the method further includes: processing, by the DSP, an instruction received from the external controller; and in response to processing the instruction, configuring, by the DSP, one or more registers at the core using data values of the instruction. In some implementations, accessing, by the core, the configured one or more registers to obtain configuration data that defines the computations for the neural network; and performing, at the computation unit, the computations based on data values derived from the instructions received from the external controller.

Particular embodiments of the subject matter described in this specification can be implemented so as to realize one or more of the following advantages. The component layout enables the circuit of a neural network processor to more efficiently perform computations. The processor includes a rotation unit and crossbar unit that are used to coordinate storing layer outputs (e.g., activations) into the activation memory as well as obtaining or reading the activations from the memory. The processor can be configured to also use the rotation unit and crossbar unit to load parameters for a layer into the parameter memory as well as read the parameters from the memory.

The processor can use the specific component features to accomplish certain memory operations in the same cycle without experiencing bank conflicts that can degrade performance of the circuit. The processor can use the specific component features to also maximize performing multiple neural network computations by obtaining a substantially high utilization rate for each computational core/cell in a computation unit of the processor. The processor is configured to support a range of stride values and skip values for a given neural network computation, e.g., computations involving convolutional layers, without compromising the high utilization of the computation unit.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example neural network processing system.

FIG. 2 shows an example data routing topology for a neural network processing system.

FIG. 3 shows an example diagram that illustrates obtaining input data to perform a convolution computation.

FIG. 4 shows an example diagram that illustrates processing input data to perform a neural network computation.

FIG. 5 shows another example diagram that illustrates processing input data to perform a neural network computation.

FIG. 6A and 6B shows a diagram that illustrates example bank assignments for input data and output data and processing the input data for a given stride value.

FIG. 7 shows diagrams that illustrate example kernel structures, a nested for loop, and a memory word for a kernel location memory.

FIG. 8 shows an example table that includes information about memory addresses of a kernel location memory.

FIGS. 9-12 each show an example diagram that illustrates processing input data for depthwise convolutions.

FIG. 13 shows an example diagram that illustrates a depthwise convolution layer that processes input data to generate output data.

FIG. 14 shows an example diagram that illustrates input windows for parallelism in a depthwise convolution.

Like reference numbers and designations in the various drawings indicate like elements.

### DETAILED DESCRIPTION

A neural network having multiple layers can be used to compute inferences. For example, given an input, the neural network can compute an inference for the input. The neural network computes this inference by processing the input through each of the layers of the neural network. In particular, the connectivity between layers of the neural network can be represented by a directed graph. Thus, a given layer within the network is configured to (i) receive as input the outputs generated by layers that are connected to the given layer by incoming edges in the directed graph and (ii) provide the output generated by the given layer as input to each layer that is connected to the given layer by an outgoing edge in the directed graph. That is, any particular layer can receive multiple inputs, multiple outputs, or both. Some or all of the layers have a respective set of parameters. Each of these layers receives an input and processes the input in accordance with the set of parameters for the layer to generate an output.

Therefore, in order to compute an inference from a received input, the neural network receives the input and processes it through each of the neural network layers in the network to generate the inference, with the output from one neural network layer being provided as input to one or more other neural network layers. Data inputs to a neural network layer, e.g., either the input to the neural network or the outputs of another layer in the directed graph, can be referred to as layer inputs or inputs to the layer. In some cases, an input to one layer of the neural network is an activation or set of activations that include activation values generated as an output of another layer of the neural network. For example, processing a layer input at a first layer can involve the first layer applying an activation function to generate a set of activation values that are an output of the first layer. The activations that are output by the first layer are then provided as a layer input to a second layer in the neural network for processing at the second layer.

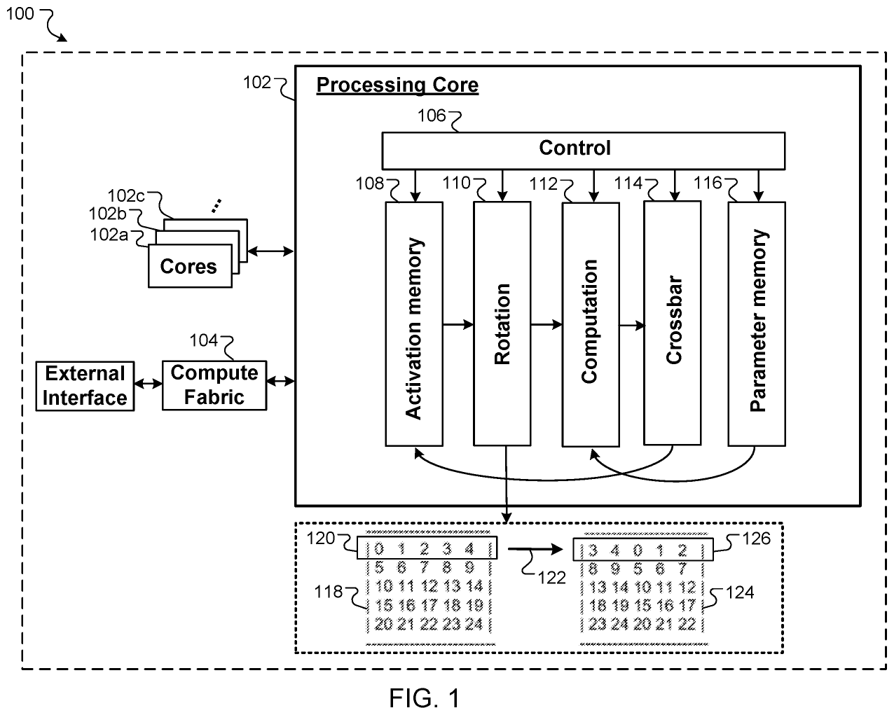

FIG. 1 shows an example system 100. The system 100 is a neural network processing system of one or more special-purpose integrated circuits for performing neural network computations. System 100 includes a core 102, e.g., of an example vector processing unit. In some implementations, the core 102 can be a vector processor core configured for accelerating performance of neural network computations. The core 102 interacts with components of system 100 to accelerate performing computations for training a neural network or for processing inference workloads using the neural network. Core 102 includes control logic 106 and multiple components that may be embodied in software or hardware features of system 100. Core 102 uses control logic 106 to provide instructions to each of the multiple components in core 102. The instructions can include data for a neural network computation. In some implementations, the instructions are received at core 102 from an external controller or host device.

Each of the multiple hardware components can convert the instructions into low level control signals that cause system 100 to perform the neural network computations. In general, the control signals regulate dataflow in the system 100, e.g., how data for the computations moves through at least the component features of core 102. In some implementations, the control logic 106 is a processor that generates clocked signals or program code executed by a processor to generate clocked signals for controlling the components in core 102. The control logic 106 can use timing of the clocked signals to, at appropriate times, send instructions and control signals to each component of the system 100. In other implementations, a host device such as an external controller passes in a clocked signal from an external processor of the controller.

Core 102 includes an activation memory 108 and a parameter memory 116. Activation memory 108 is configured to store data, such as inputs or input activations, which is processed through one or more layers of a multi-layer neural network. Activation memory 108 is also configured to store outputs or output activations of a layer. As indicated above, a first layer of a neural network receives a layer input and generates activations (e.g., a layer output). The first layer may (or may not) have an activation function which represents a non-linearity function, such as ReLU, sigmoid, or tan h, that provides the non-linearity in a neural network. The activations generated by the first layer can be processed through a second or subsequent layer of the neural network. Parameter memory 116 can be configured to store sets of parameters for one or more layers of the multi-layer neural network.

In some implementations, the system 100 includes multiple cores 102 and multiple computation fabrics 104 (described below). Each core 102 of the multiple cores includes an activation memory 108 and a parameter memory 116 and is configured to communicate with a respective computation fabric 104. In this implementation, one or more cores 102 can use their respective parameter memory 116 to store parameters for a certain layer, or portions of layers, that are assigned to a given core 102. In general, processing an input through a layer of a neural network is accomplished by performing mathematical operations, e.g., multiplication and addition.

As described below, the operations are performed using computation circuitry of an example neural network processor, such as an example neural network on a hardware circuit of system 100. The mathematical operations can differ based on the type of neural network or the type of neural network layer that is used to process the input.

A convolutional neural network (CNN) can be configured based on a presumption that inputs to the neural network correspond to image pixel data for an image or other data that includes features at multiple locations. For example, sets of inputs can form a multi-dimensional data structure, such as a tensor, that represent color features of an example digital image (e.g., an image of the surroundings of a vehicle). In some implementations, inputs to the neural network correspond to a variety of other types of data, such as data obtained from different devices and sensors of a vehicle, point cloud data, audio data that includes certain features or raw audio at each of multiple time steps, or various types of one-dimensional or multiple dimensional data. A convolutional layer of the convolutional neural network can process the inputs to transform features of the image that are represented by inputs of the data structure. For example, the inputs are processed by performing dot product operations using input data along a given dimension of the data structure and a set of parameters for the convolutional layer.

Performing computations for a convolutional layer can include applying one or more sets of kernels to portions of inputs in the data structure. The manner in which a system performs the computations can be based on specific properties for each layer of an example multi-layer neural network or deep neural network that supports deep neural net workloads. A deep neural network can include one or more convolutional towers (or layers) along with other computational layers. In particular, for example computer vision applications, these convolutional towers often account for a large proportion of the inference calculations that are performed. Convolutional layers of a CNN can have sets of artificial neurons that are arranged in three dimensions, a width dimension, a height dimension, and a depth dimension. The depth dimension corresponds to a third dimension of an input or activation volume and can represent respective color channels of an image. For example, input images can form an input volume of data (e.g., activations), and the volume has dimensions 32×32×3 (width, height, depth respectively). A depth dimension of 3 can correspond to the RGB color channels of red (R), green (G), and blue (B).

In general, layers of a CNN are configured to transform the three dimensional input volume (inputs) to a multi-dimensional output volume of neuron activations (activations). For example, a 3D input structure of 32×32×3 holds the raw pixel values of an example image, in this case an image of width 32, height 32, and with three color channels, R,G,B. A convolutional layer of a neural network of system 100 computes the output of neurons that may be connected to local regions in the input volume. Each neuron in the convolutional layer can be connected only to a local region in the input volume spatially, but to the full depth (e.g., all color channels) of the input volume. For a set of neurons at the convolutional layer, the layer computes a dot product between the parameters (weights) for the neurons and a certain region in the input volume to which the neurons are connected. This computation may result in a volume such as 32×32×12, where 12 corresponds to a number of kernels that are used for the computation. A neuron's connection to inputs of a region can have a spatial extent along the depth axis that is equal to the depth of the input volume. The spatial extent corresponds to spatial dimensions (e.g., x and y dimensions) of a kernel.

A set of kernels can have spatial characteristics that include a width and a height and that extends through a depth of the input volume. Each set of kernels for the layer is applied to one or more sets of inputs provided to the layer. That is, for each kernel or set of kernels, the system 100 can overlay the kernel, which can be represented multi-dimensionally, over a first portion of layer inputs (e.g., that form an input volume or input tensor), which can be represented multi-dimensionally. For example, a set of kernels for a first layer of a CNN may have size 5×5×3×16, corresponding to a width of 5 pixels, a height of 5 pixel, a depth of 3 that corresponds to the color channels of the input volume to which to a kernel is being applied, and an output dimension of 16 that corresponds to a number of output channels. In this context, the set of kernels includes 16 kernels so that an output of the convolution has a depth dimension of 16.

The system can then compute a dot product from the overlapped elements. For example, system 100 can convolve (or slide) each kernel across the width and height of the input volume and compute dot products between the entries of the kernel and inputs for a position or region of the image. Each output value in a convolution output is the result of a dot product between a kernel and some set of inputs from an example input tensor. The dot product can result in a convolution output that corresponds to a single layer input, e.g., an activation element that has an upper-left position in the overlapped multi-dimensional space.

As discussed above, a neuron of a convolutional layer can be connected to a region of the input volume that includes multiple inputs. System 100 can convolve each kernel over each input of an input volume. System 100 performs this convolution operation by, for example, moving (or sliding) each kernel over each input in the region.

System 100 moves each kernel over inputs of the region based on a stride value for a given convolutional layer. For example, when the stride is set to 1, then system 100 moves the kernels over the region one pixel (or input) at a time. Likewise, when the stride is 2, then system 100 moves the kernels over the region two pixels at a time. Thus, kernels may be shifted based on a stride value for a layer and the system 100 can repeatedly perform this process until inputs for the region have a corresponding dot product. Related to the stride value is a skip value or dilation value. The skip value can identify one or more sets of inputs (for example, 2×2), in a region of the input volume, that are skipped when inputs are loaded for processing at a neural network layer. In some implementations, an input volume of pixels for an image can be “padded” with zeros, e.g., around a border region of an image. This zero-padding is used to control the spatial size of the output volumes.

As discussed above, a convolutional layer of CNN is configured to transform a three dimensional input volume (inputs of the region) to a multi-dimensional output volume of neuron activations. For example, as the kernel is convolved over the width and height of the input volume, system 100 produces a multi-dimensional activation map that includes results of convolving the kernel at one or more spatial positions based on the stride value. In some cases, increasing the stride value produces smaller output volumes of activations spatially. In some implementations, an activation function can be applied to outputs of the convolution before the outputs are sent to a subsequent layer of the neural network.

An example convolutional layer can have one or more control parameters for the layer that represent properties of the layer. For example, the control parameters can include a number of kernels, K, the spatial extent of the kernels, F, the stride (or skip), S, and the amount of zero padding, P. Numerical values for these parameters, the inputs to the layer, and the parameter values of the kernel for the layer shape the computations that occur at the layer and the size of the output volume for the layer. In one implementation, the spatial size of the output volume is computed as a function of the input volume size, W, using the formula (W−F₊₂P)/S₊₁. For example, an input tensor can represent a pixel input volume of size [227×227×3]. A convolutional layer of a neural network can have a spatial extent value of F=11, a stride value of S=4, and no zero-padding (P=0). Using the above formula and a layer kernel quantity of K=96, system 100 performs computations for the layer that results in a convolutional layer output volume of size [55×55×96], where 55 is obtained from [(227−11+0)/4+1=55].

The computations (e.g., dot product computations) for a convolutional layer, or other layers, of a neural network involve performing mathematical operations, e.g., multiplication and addition, using multiple computing cells of a hardware circuit of system 100. The design of a hardware circuit can cause a system to be limited in its ability to fully utilize computing cells of the circuit when performing computations for layers of a neural network.

Based on the techniques described in this document, system 100 can natively support performing computations for a variety of neural network layers. For example, system 100 can be configured to support convolutional layers with different properties, while concurrently achieving improvements in a percentage of computing cells (described below) that are utilized to perform certain types of neural network computations for each of the different layers. In some implementations, the different properties for a convolution layer can correspond to a size of the matrix structure of parameters that represent a kernel, the quantity of kernels representing a depth of a layer and that are applied to a data structure of inputs, or a stride (or skip) value for applying a kernel to a region of inputs.

In some implementations, multi-dimensional data structures that are processed by a neural network layer represent input features of digital images, e.g., digital images captured by imaging sensors of a vehicle traversing a road or terrain. For these implementations, by processing the inputs through the various layers of the neural network, system 100 computes multiple sets of inferences that can be used to navigate the vehicle while the vehicle traverses the terrain.

Core 102 also includes a rotation unit 110, a computation unit 112, and a crossbar unit 114. Control logic 106 is used to send sets of activation inputs and sets of parameter inputs to computation unit 112. The computation unit 112 includes circuitry for performing mathematical operations, e.g., multiplication and addition. This circuitry includes multiple computing cells that are configured to perform mathematical operations using the sets of activations inputs and parameters. For example, computation unit 112 can include one or more multiply accumulate cells (MACs) that each receive sets of activations and parameters that are obtained from activation memory 108 and parameter memory 116, respectively. Computation unit 112 processes the inputs and parameters to generate a set of outputs.

Rotation unit 110 communicates with activation memory 108 to obtain input data for processing at a layer and provides the obtained inputs to MACs of the computation unit 112. As described below, rotation unit 110 receives and rotates layer inputs accessed from memory address locations of activation memory 108. The layer inputs are rotated based on rotation instructions determined by control logic 106. The rotation instructions define the amount of rotation and allow inputs to be obtained from the address locations and moved to computation unit 112 in a manner that optimizes use of the MACs at the computation unit. In some implementations, example logical connections for a circuit of system 100 can include the rotation unit 110 being logically connected, or physically coupled, at a portion of the circuit to enable data (inputs or activations) to be received from the activation memory 108 and provided to the computation unit 112. Similarly, the crossbar unit 114 can be logically connected between the computation unit 112 and the activation memory 108 to enable output data of the computation unit 112 to be provided to activation memory 108 for storing in a memory bank, while computation unit 112 is logically coupled or connected to parameter memory 116 to receive weights from the parameter memory for performing computations. In other implementations, the rotation unit 110 and crossbar unit 114 are both located, e.g., logically, between activation memory 108 and computation unit 112. In some implementations, inputs and outputs of computation unit 112 are multi-dimensional data structures.

Neural network processors that employ architectures which differ from the special-purpose circuit described in this specification can experience memory bank conflicts during certain memory operations. Bank conflicts can preclude reading and writing data from memory in the same cycle, which can degrade performance and computing efficiency of a neural net processor.

In general, a circuit may have a section of shared memory that is divided into multiple banks of memory (“memory banks”) and a respective set of address locations for each bank in the multiple memory banks. In some instances, each bank can only address one dataset at a time. So, if a system tries to load (or store) data from (or to) the same bank, then access to address locations of the memory bank must be serialized, i.e., the system cannot access two locations in the same bank in parallel. This required serialization is referred to as a bank conflict. For example, if two memory locations (addresses) occur in the same bank, then a bank conflict occurs and access to the address locations is processed serially thereby losing the advantages of parallel access. As described in more detail below, rotation unit 110 and crossbar unit 114 can be used to obtain data from, or store data in, activation memory 108 and parameter memory 116 in the same cycle without the occurrence of a memory bank conflict at system 100.

Rotation unit 110 is configured to obtain data from activation memory 108 for processing through a layer. As noted above, the data can be a set of activations that form a multi-dimensional data structure (e.g., an array or a tensor) associated with a portion of the digital image. This multi-dimensional data structure shall be henceforth referred to as, a basic tensor unit of input activations, such as an example bₓ×b_{y}×b_{z}, 3D tensor. The basic tensor unit, hereinafter, refers to the 3D tensor structure which can be loaded from the activation memory 108 at once and passed to the rotation unit 110, and it is the basic data unit processed in system 100. In the core 102, a layer of the neural network can process an input of a particular size and generate an output of another size. The output may be a set of activations that are stored at activation memory 108. The set of activations are later obtained using an address location of activation memory 108 and provided as an input to another layer of the neural network. In some implementations, rotation unit 110 is used to rotate the sets of activations accessed from address locations of activation memory 108.

By way of illustration, a neural network can include layers 1, 2, and 3 that are configured for processing data associated with a three dimensional tensor. Layer 1 can process a 170×170×3 image and output a 28×28×96 tensor of activation values. The 28×28×96 tensor of activation values is processed by Layers 2-3, and the output of Layer 3 can be used to generate an inference of the neural network. In some implementations, layers 1-3 can be convolutional layers or fully connected layers. In some cases, one or more of the layers can be a pooling layer, a non-linear layer, or a classifier layer.

Crossbar unit 114 is used to generate certain bank assignment patterns based on specific computing instructions obtained from control logic 106. The bank assignment patterns are generated such that data can be stored after processing by one layer and read back for processing by the next layer without a memory bank conflict occurring for multiple read operations performed during a single clock cycle. This bank assignment feature of the crossbar unit 114 is particularly advantageous because it enables the data to be stored and accessed for a next layer without bank conflict even when the next layer has a different stride value than a current layer. In this manner, data can be obtained from, or written to, memory of system 100 based on unique patterns that use address locations for respective banks of the memory.

In a single clock cycle, the rotation unit 110 and crossbar unit 114 can each execute instructions for processing the bank assignment patterns generated during neural network computations performed at system 100. For example, when processing input data for an image, rotation unit 110 can rotate accessing inputs by one or more pixels every clock cycle.

In some implementations, the rotation unit 110 processes instructions or control signals received from control logic 106 to perform a rotation operation on an example basic tensor unit. The control signals can define an x-rotation factor for an x-dimension of a 3D tensor and/or define a y-rotation factor for a y-dimension of the 3D tensor. For example, given a basic tensor unit that is stored in activation memory 108, the rotation unit 110 can process control signals received from the control logic 106 to rotate a position of input data elements in the tensor based on a rotation factor defined by the control signals. In response to processing the control signals, the rotation unit 110 can rotate input data for elements of the tensor along an x-dimension of the tensor based on the x-rotation factor and/or rotates input data for elements of the tensor along a y-dimension based on the y-rotation factor.

In some implementations, when the rotation unit 110 rotates the input data along the x-dimension, each individual data element along the x-dimension is shifted in the x-direction by the same amount, e.g., by an amount defined by the x-rotation factor. The amount can be based on an integer value that indicates the number of positions that an element is shifted along a given dimension during a rotation operation. For example, as shown at FIG. 1, a given 2D basic tensor unit 118 can include 5×5 individual data elements. Core 102 uses control logic 106 to cause the rotation unit 110 to rotate input data along an x-dimension 120 of 2D tensor 118. In this example, individual data elements of 2D tensor 118 are shifted in the x-direction 122 to create a rotated 2D tensor 124. As shown, the 2D tensor 124 has an x-dimension 126 where individual data elements are shifted by the same amount, e.g., by an amount of two. In general, an amount that individual data elements are shifted is defined by the x-rotation factor, the y-rotation factor, or both.

As described in more detail below, system 100 can determine a rotation scheme based at least on a configuration of computing cells at computation unit 112, as well as other properties of a current neural network layer, e.g., a convolutional layer, and the inputs to the layer that are processed using the computing cells. System 100 uses the determined rotation scheme to cause the rotation unit 110 to rotate accessing inputs for a layer. In general, the rotation unit 110 is responsible for ensuring inputs that are needed for a given output value are accessed and provided to the appropriate computing cell of computation unit 112 that corresponds to the output value. In some implementations, the rotation unit 110 performs a certain number of rotation operations in parallel during a single clock cycle.

The rotation unit 110 can execute the data rotations to enable system 100 to perform sets of neural network computations in parallel over one or more clock cycles. In this manner, rotation unit 110 and crossbar unit 114 are configured such that system 100 can achieve a relatively high utilization (e.g., >80% utilization) of the computing blocks in computation unit 112 that include multiple computing cells or MACs. For example, rotation unit 110 is configured to enable system 100 to support any stride value and any skip value for a given neural network computation, with minimal (or no) loss in the high utilization of computation unit 112.

One or more factors can affect the system's utilization of computation unit 112. In some implementations, for a multi-dimensional tensor (e.g., h×w×d), characteristics of individual dimensions of the multi-dimensional tensor can affect utilization of computing blocks at computation unit 112. For example, if system 100 processes an h×w×d 3D input activation tensor, then utilization of computation unit 112 is maximized when respective dimensions of the 3D input tensor (e.g., a number of elements along a dimension) correspond to a certain integer multiple of the basic tensor unit dimensions (bₓ×b_{y}×b_{y}), such as 2×2×1 and integer multiples 6×6×3, or 10×12×6 and integer multiples 20×36×12. Hence, system 100 can be configured to have a computing architecture that favors an example input tensor h×w×d with some number of dimensional elements that are multiples of a specific height value (b_{y}), width value (b_{y}), or depth value (b_{y}) of the basic tensor unit. Using this integer multiple implementation, then the system 100 can achieve 100% utilization of computation unit 112 regardless of the stride value and/or skip value for a given neural network layer. In other implementations, system 100 can be configured such that a variety of other basic tensor unit configurations and corresponding integer multiples can be used to achieve 100% utilization irrespective of the stride value and/or skip value for a neural network layer.

As described herein, the computation unit 112 can include a large quantity of computational cells or MACs that are used to perform mathematical operations for processing neural network inputs through layers of the neural network. In some implementations, using the bank assignment patterns executed by rotation unit 110 and crossbar unit 114, system 100 can achieve a higher core utilization when computations are performed for certain types of neural network layers. Using these component features, system 100 can also achieve relatively high core utilization for a variety of stride values and skip values. Core utilization refers to a percentage of MACs at computation unit 112 that are used to execute computations for processing an input. In some cases, core utilization is determined with reference to a single clock cycle or with reference to multiple clock cycles.

Crossbar unit 114 uses instructions for the bank assignment pattern to facilitate storing activations in the memory of system 100, e.g., activation memory 108. The activations are generated by one layer and the crossbar unit 114 uses the bank assignment pattern to store the activations in a manner that allows them to be accessed from the memory and used as inputs to a next or subsequent layer in the neural network. Using the crossbar unit 114 and instructions for the bank assignment patterns, activations can be stored, e.g., at specific address locations of activation memory 108, and later accessed for use as inputs to the next layer without bank conflict, even if the next layer has a different stride or skip value than the previous layer that generated the activations.

In some implementations, the crossbar unit 114 references a stride value and/or a certain skip value for a subsequent layer (described below). In some implementations, the crossbar unit 114 is a sparse crossbar that uses at least one-stage or a two-stage process for storing output data. This one-stage or two-stage process can be used to store, in activation memory 108, an example output data array/tensor in accordance with at least a row and column format. For example, during a first stage for storing the output data, crossbar unit 114 executes a first shuffling operation to shuffle or adjust data associated with a row of the array. During a second stage for storing the output data, crossbar unit 114 executes a second shuffling operation to shuffle or adjust data associated with a column of the array. In some cases, the crossbar unit 114 executes at least one shuffling operation to shuffle or adjust data associated with both a row and column of a tensor.

In general, each of the rotation unit 110 and crossbar unit 114 use instructions for the bank assignment pattern to access input data for a set of inputs or activations and store output data without a bank conflict occurring at activation memory 108. The bank pattern enables output data to be written to activation memory 108 after processing by one layer and then read or obtained from activation memory 108 for processing by a next subsequent layer without address conflicts occurring at the respective banks which form activation memory 108.

By rotating the accessed input data, the rotation unit 110 leverages a control feature of system 100 that optimizes accessing input data for processing through a layer of the neural network. For example, rotating data access based on a specified pattern facilitates parallel access, during a single clock cycle, to sets of inputs stored at address locations of the different banks at activation memory 108. This enables respective sets of activations and parameters to be provided to each of the multiply accumulate cells (MACs) from activation memory 108 and parameter memory 116.

As indicated above, crossbar unit 114 can reference a stride value and/or a certain skip value for a subsequent layer. For example, a set of input activations for a first portion of an image is processed at the first layer. This processing generates a set of output data that has a particular number of elements that correspond to output activations. These elements are then accessed for processing by the next subsequent layer of the neural network. In some implementations, a particular stride value is assigned for a next layer or a particular skip value is assigned for the next layer.

For example, the skip value can identify one or more sets of elements that are skipped when data inputs are loaded for processing at a neural network layer. In some implementations, a skip can be supported by loading adjacent bₓ×b_{y} pixels using any staggered sliding window access scheme to traverse [row, column] elements of an input data array. In this example, bₓ and b_{y} can each represent respective integer values greater than or equal to one, e.g., 3×3 pixels or 2×2 pixels. Based on the bank assignment pattern and the rotation and crossbar features of core 102, any bₓ×b_{y} patch of elements from the input data array can be loaded in one cycle without a bank conflict. Thus, any skipping value can be supported at system 100 based on the described techniques. For a given convolution layer of a neural network, a convolution having a skip can be also referred to as a dilated convolution, where the skip value corresponds to a dilation factor. In the context, dilation can support exponential expansion of a receptive field without loss of resolution or coverage. For example, a skip value of two (e.g., a 2-dilated convolution) applied to a 3×3 kernel causes expansion of the initial 3×3 receptive field, e.g., to 5×5, as the individual kernel parameters appear to skip one pixel as the kernel parameter appears every two pixels.

The stride value defines an amount that each kernel is shifted when the kernel is applied to input data (e.g., pixel values) for another portion of the image. In some implementations, a stride value, e.g., stride=8, is referenced when storing activations generated for a current layer that will be used as a layer input to a subsequent layer. In some cases, the stride value can be referenced to load bₓ×b_{y} pixels elements that are not adjacent to each other in a two-dimensional (2D) window that represents elements of an input tensor. In general, system 100 can be configured to support any stride value without restriction.

During each clock cycle, a set of elements of the output data are received at activation memory 108. Based on bank assignment patterns, these elements are stored in a manner that accounts for the stride value of the next layer. The generated bank assignment patterns define the particular memory bank that is assigned for each set of data elements. Control logic 106 is configured to generate a unique bank assignment pattern for the next layer to facilitate storing the elements with a particular stride value (for example, stride=8) and to prevent bank conflicts when system 100 obtains elements for processing by the next layer. In some implementations, control logic 106 generates a unique bank assignment pattern for each layer of a multi-layer neural network.

Activation memory 108 can be configured as a shared memory that is used by core 102 and a flexible computation fabric 104 (e.g., a digital signal processor (DSP) or other scalar or vector processors) during the computations for the various neural network layers. In some cases, computation fabric 104 is represented at a circuit of system 100 by an example processing device that can support computations processed at deep neural network layers. Sharing data between core 102 and computation fabric 104 provides more efficient and versatile support of neural network layers in different computation fabrics. Computation fabric 104 provides enhanced programmability that cause core 102 to obtain and process instructions for using the rotation and crossbar features and for using the bank assignment patterns. The computation fabric 104 can be configured to receive instructions from a host device or external controller that are processed and sent to core 102. The instructions can include data values for configuring registers or other data processing devices at core 102. The core 102 and computation fabric 104 can interact to provide complimentary data processing functions within system 100. For example, the computing cells of the computation unit 112 in core 102 can be used to accelerate computations for deep net workloads, while the computation fabric 104 enables workloads for specific deep net layers to be completed with improved efficiency.

In some implementations, each layer in an example deep net can be executed either in the computation fabric 104 or the core 102. When a layer is executed in the core 102, the input data is loaded from activation memory 108, routed through rotation unit 110, computation unit 112, and crossbar unit 114, and then the output data is written to activation memory 108. For example, output data that is generated from the input data, using the computation unit 112, is then routed through crossbar unit 114, before being stored as output in the memory banks of activation memory 108. When a layer is executed in the computation fabric 104, the input data is loaded from activation memory 108, routed to the computation fabric 104 for computation, and then the output data is written to activation memory 108.

In some implementations, system 100 includes at least two respective sets of computation units, the computation units of the core 102 (e.g., unit 112) and the computation units of the computation fabric 104. Core 102 can be configured to support computations for neural net layers including dense/depthwise convolution, fully-connected, non-linear operations (e.g., applying activation functions), and pooling operations. The core 102 is also configured to support computations for a data arrangement layer, such for as performing depth concatenation. The computation fabric 104 is configured to support one or more other neural net layers and can be used to perform computations for operations associated with these other layers.

In the core 102, an example computation path can run in the following manner. A set of computations are performed in computation unit 112, e.g., computations for convolution and fully-connected layers. In some implementations, computation unit 112 is configured to also include hardware components for using non-linear functions and completing pooling operations, where the components may be running in a pipeline configuration. The computation unit 112 can generate a full-sum in response to performing computations for a convolution. In some implementations, the full-sum is routed to a non-linear unit of the core 102 for applying an activation function, while in other implementations, this routing operation can be skipped. In some cases, an output of the non-linear unit is routed to a pooling unit of the core 102 to complete a pooling operation, while in other cases, this routing can be also skipped. A final output of the computation unit 112 is routed to the crossbar unit 114. As described herein, the crossbar unit 114 uses bank assignment patterns to write/store data values of the final output at address locations of memory banks in activation memory 108. This example computation path and related data routing does not involve the computation fabric 104.

As noted above, each layer in an example deep net can be executed either in the computation fabric 104 or the core 102. When a layer is executed in the computation fabric 104, the input data is loaded from activation memory 108, routed to the computation fabric 104 for computation, and the final output data of a computation is written to activation memory 108. In some implementations, the computation fabric 104 is used to perform particular types of computations that may be unsupported in the core 102. For example, the computations can be for an argmax layer to obtain an index of the max values within a vector of values. The computation fabric 104 is configured for data communication with the activation memory 108. In some cases, an output (A) of a previous layer is written to activation memory 108 for storage in a memory bank. The computation fabric 104 can be configured to: i) read or obtain data for the previous layer output_A, ii) route the data as an input to another layer, iii) perform computations for that layer using the computation units of the computation fabric 104 to generate an output (B), and iv) then write/store data for this output_B in activation memory 108. The core 102 may then be used to obtain the data for output_B, from activation memory 108, to compute one or more other layers.

In general, the computation fabric 104 is configured to manage and execute control and data synchronization to process inputs at various layers of a neural network. In some implementations, the computation fabric 104 is used to program registers in core 102 by loading instructions and control values at different registers in the core 102. The control values can define a bank assignment pattern including stride and skip values for a neural network computation. The instructions are executed by rotation unit 110 and crossbar unit 114 to process bank assignment patterns with reference to the stride and skip values. In other implementations, the core 102 can include a scalar processor that is used by the core 102 to perform the control and data synchronization functions. The scalar processor is configured for data communications with the computation fabric 104 and can be directly programmed using the computation fabric 104.

System 100 can include multiple sub-systems, where each sub-system includes a respective core 102. For example, a first sub-system can include core 102a, a second sub-system can include core 102b, and a third sub-system can include core 102c. Cores 102a, 102b, and 102c can correspond to neighboring cores of system 100. Example border pixel logic of system 100 can be used to facilitate data sharing between neighboring cores 102a, 102b, and 102c that are included in each sub-system of system 100, as discussed above. For example, edge pixel values of an image can be shared for parallel processing by cores 102a/b/c using the border pixel logic of core 102. An example data arbiter of core 102 can be used to control information received by the different interfaces of system 100. For example, a data arbiter can include control logic for prioritizing and distributing information provided by computation fabric 104, by control logic 106, or by a host device such as an external controller.

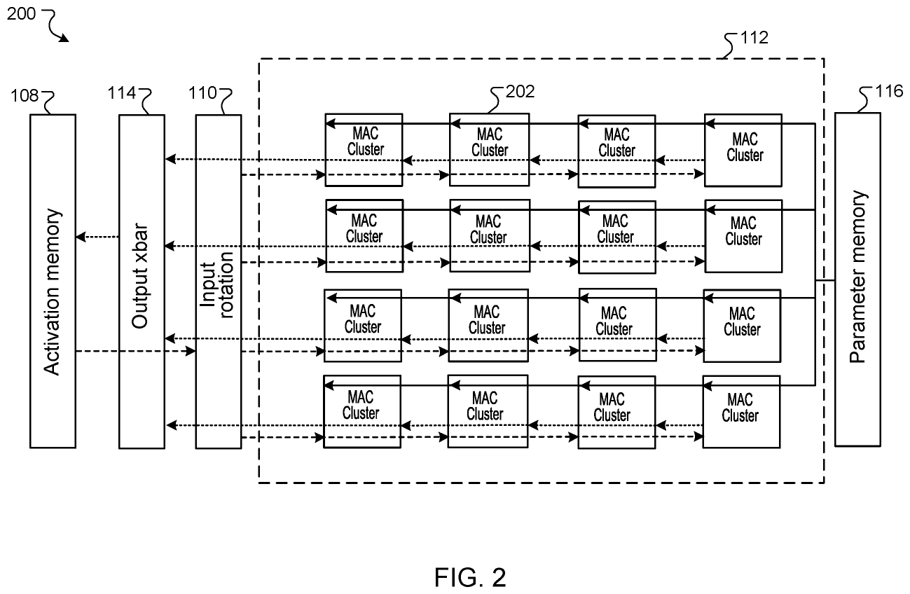

FIG. 2 shows an example data routing topology 200 for a neural network processing system 100. Routing topology 200 generally includes data routing lines that represent rotating access of inputs that are provided to multiple of the respective cells in computation unit 112. For example, an input data structure of a certain size (e.g., an input basic tensor unit) can be obtained from activation memory 108. Computation unit 112 can include respective computing blocks 202 that each include a cluster of MACs. Although 16 computing blocks are shown in FIG. 2, the system 100 can be designed to include more or fewer computing blocks 202. Each of the MAC clusters can be used to compute a portion of a larger dot product based on the example input data. In some implementations, the respective portions of the larger dot product are computed in parallel during the same clock cycle.

During example computations for a convolution layer, a MAC may correspond to a given output value in the output of the convolution. In some implementations, system 100 determines a rotation scheme based on a particular MAC that corresponds to the given output value in the output of the convolution. In some cases, an example rotation scheme can define how data for a layer is rotated based on the particular MAC that will receive the data. System 100 uses the determined rotation scheme to cause the rotation unit 110 to rotate the accessed input basic tensor unit for a layer. The rotation unit 110 is responsible for ensuring inputs that are needed for a given convolution output value are accessed and provided to the appropriate MAC that corresponds to the output value. Rotation unit 110 rotates the accessed input basic tensor unit based on bank assignment patterns processed using the control logic 106. For example, the control logic 106 generates rotation factors based on the bank assignment patterns, where the rotation unit 110 uses the rotation factors to rotate the data for a layer.

For a rotation, the rotation unit 110 can access a portion of data (e.g., for a basic tensor unit) and provide the accessed data to a MAC cluster of a computing block 202 in computation unit 112. In every cycle, each computing block 202 receives a portion of data from the rotation unit 110. The data routing pattern between the rotation unit 110 and the computing block 202 can be different for different operation modes (e.g., modes such as dense convolution, depthwise convolution, etc.). In some implementations, the rotation unit 110 performs each of these rotation operations in parallel during a single clock cycle. In other implementations, some or all of the computing blocks 202 in computation unit 112 are used to compute the larger dot product in parallel over one or more clock cycles.

For example, when computing a larger dot product, one or more of the computing blocks 202 can each receive a respective portion of data that represents parameters for a neural network layer. Each computing block 202 can use its MAC cluster to perform a portion of the dot product computation using the portion of data for the activation inputs and the portion of data for the parameters. In some cases, the computing blocks 202 can generate respective sets of output data. The sets of output data are provided to crossbar unit 114 for processing and storing at address locations for the individual memory banks that form activation memory 108.

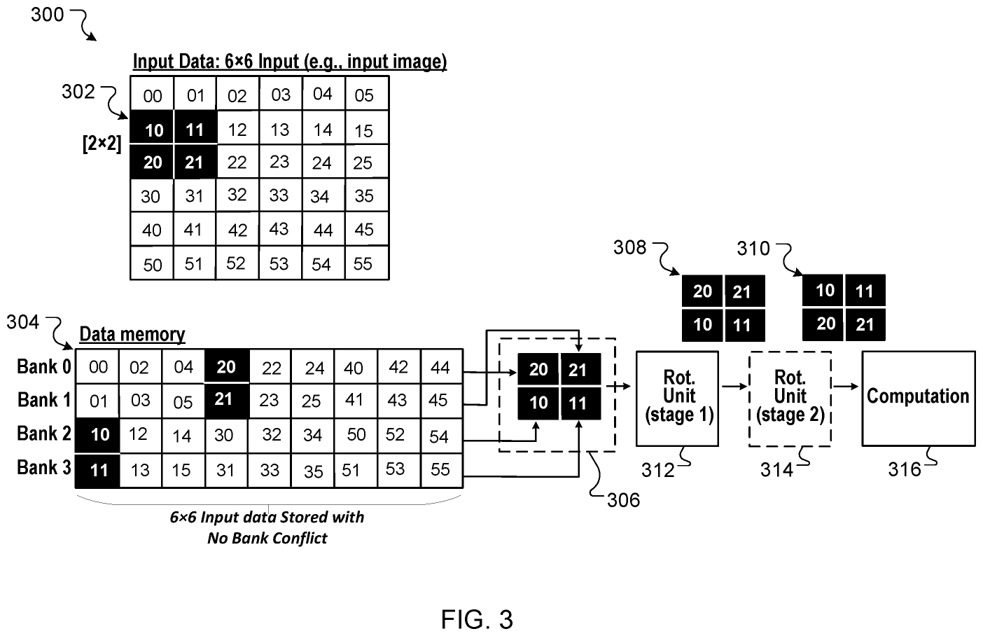

FIG. 3 shows an example diagram 300 that illustrates input data that is obtained from activation memory 108 and used to perform an example neural network computation. Diagram 300 shows a first input window 302 that includes an example input data structure having multiple elements (e.g., 00, 01, 02, 03, etc.). Each element has a corresponding input value (e.g., a pixel value) to be processed at a neural network layer, such as a convolutional neural network layer. In FIG. 3, the numerical references of input window 302 (i.e., 10, 11, 20, 21) can correspond to respective positions or elements of an input tensor to which an input value is mapped. Each input (e.g., an activation) that corresponds to an element of an input tensor can be stored at a respective memory address location of data memory 304. For example, data memory 304 can include memory bank 0, memory bank 1, memory bank 2, and memory bank 3, and an input of element 00 (“input 00”) can be stored at an example memory address location of memory bank 0. The memory banks of data memory 304 can correspond to example memory banks of activation memory 108.

As described above, in some implementations, inputs to a current neural network layer can be output activations from a previous layer that were stored at address locations of activation memory 108 using crossbar unit 114. The crossbar unit 114 stores the output activations, e.g., causes the output activations to be stored, based on a bank assignment pattern such that the activations can be accessed, without bank conflict, and used as inputs to the current neural network layer for processing at the current layer. Data pattern 306 shows an example of how elements of an example data structure 308 may be arranged when inputs or activations mapped to the elements are obtained from data memory 304 for processing at a current neural network layer. The particular elements of the data structure 308 to which respective inputs are mapped may be arranged, e.g., as shown at data pattern 306, based on the bank assignment pattern that was used to store the output activations at the address locations at data memory 304 (of activation memory 108). For example, because crossbar unit 114 stores data at activation memory 108 using a specific bank assignment pattern, when the stored data is later accessed it is arranged in a manner that is consistent with, or that corresponds to, the specific bank assignment pattern that crossbar unit 114 used to store the data, such as example data pattern 306.

In some implementations, when input data accessed from data memory 304 is arranged based on a prior bank assignment pattern, the accessed input data can be rotated using rotation unit 110 to align with an input data layout of input window 302. As indicated above, the rotation unit 110 can use rotation stages 312, 314 to rotate input data. For example, at least one rotation stage can be used to obtain an input data structure 310 that matches the data layout of input window 302. In some implementations, input data at elements of input data structure 308, arranged based on pattern 306, can correspond to pixel values of a digital image. In this context, rotating the input data using one or more rotation stages of the rotation unit 110 causes the pixel values of the input data to align with the pixel positions of the digital image, as indicated at input window 302. The rotated data structure 310 is then routed to a computing block 202, or set of MACs, to perform a computation 316.

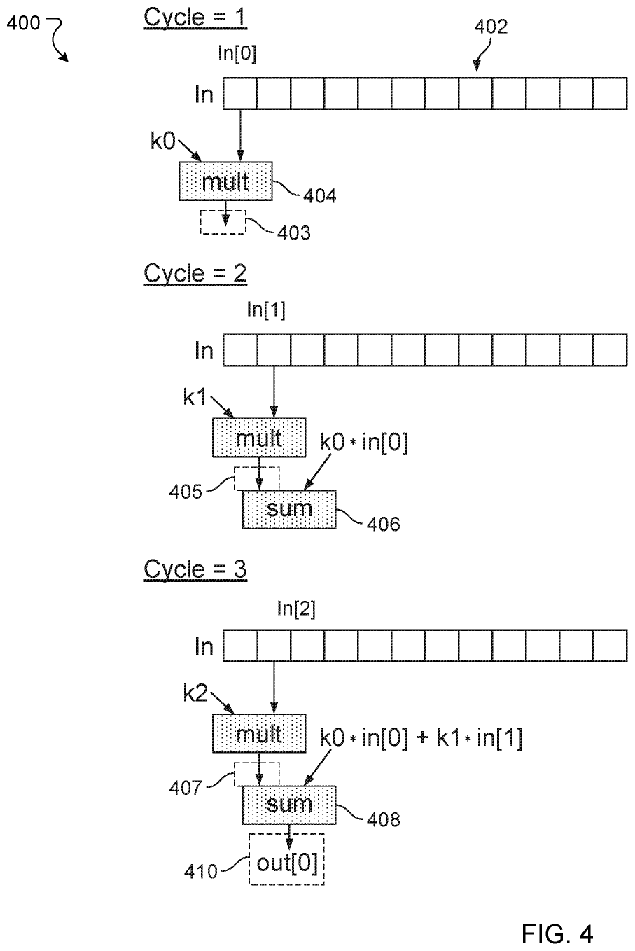

FIG. 4 shows an example diagram 400 that illustrates processing input data 402 to perform a neural network computation, e.g., using a stride=1 and a skip=1. The computation can involve a 1D tensor. But, as described below, the computation can be also extended to higher dimensional tensors, e.g., 2D or 3D tensors. In this implementation, the input data is processed to compute convolutions for a given neural network layer using a conventional hardware circuit. Hence, diagram 400 relates to a conventional circuit where only one multiplier 404 is used to compute a convolution for a given layer. The description of diagram 400 illustrates an example process of computing a convolution with reference to the limited capabilities of the conventional circuits. The descriptions also provide context for demonstrating the enhanced features and computational advantages provided by the special-purpose hardware circuits described in this document with reference to system 100.

As indicated at diagram 400, using the one multiplier of the conventional hardware circuit, in a first cycle (cycle=1), input value in[0] is loaded at the conventional circuit and multiplied with parameter k0 to generate a first result or product 403, using multiplier 404. In a next or second cycle (cycle=2), the conventional circuit computes in[1]*k1, using the multiplier 404, to generate a second result 405. The circuit can then accumulate or add the first/previous result 403 with the second result 405 to generate sum 406. In a next/third cycle (cycle=3), the conventional circuit uses the single multiplier 404 to compute in[2]*k2 and generate a third result 407. The conventional circuit can then accumulate or add the sum 406 with the third result 407 to generate sum 408.

In some cases, result 403, result 405, sum 406, and result 407 are each partial sums that are accumulated over several processor cycles to generate an example output activation. Sum 408 can correspond to an activation output 410, out[0], which is generated for the given layer. Diagram 400 can be associated with an example conventional circuit that lacks at least some of the features of the specialized hardware circuits of system 100 that contribute to the improved efficiency for loading/storing multiple 3D tensors.

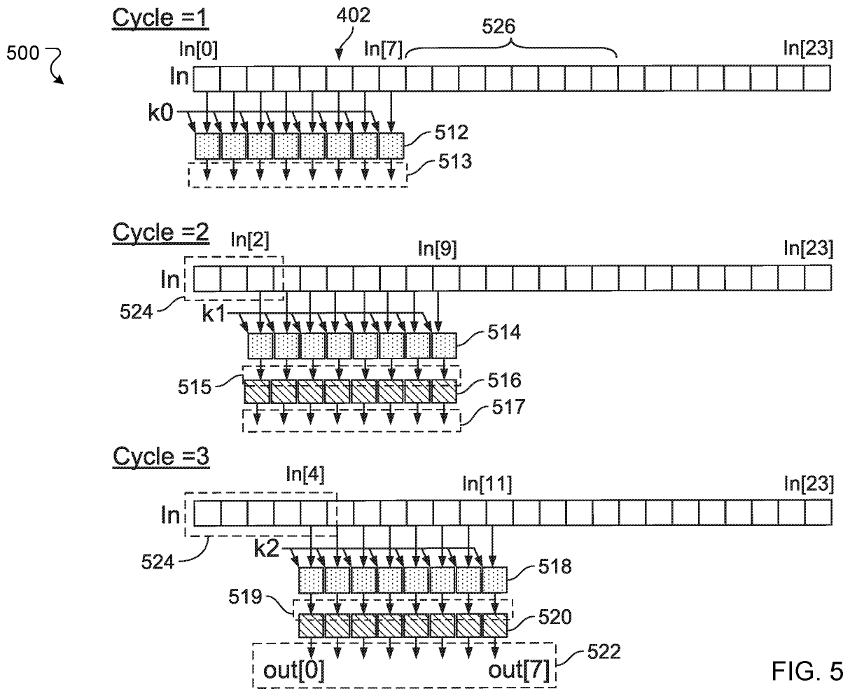

FIG. 5 shows another example diagram that illustrates an improved approach for processing input data to perform a neural network computation. In some implementations, the input data is processed to compute convolutions for a given neural network layer using a stride and/or skip value assigned for that layer. As noted above, the description of diagram 400 of FIG. 4 illustrates an example process for computing a convolution with reference to the limited capabilities of conventional circuits. In contrast, diagram 500 of FIG. 5 provides an improved approach over conventional systems that are used to process input data for computing convolutions.

In the implementation of FIG. 5, sets of input data 402 (For example, the input basic tensor unit in the 1D example in FIG. 5) can be processed in parallel using the several multipliers of a MAC that are included at an example computing block 202 of a special-purpose hardware circuit included in system 100. For example, system 100 can be configured to extend or expand its parallelism by using each of the several multipliers to multiply different activations, in a batch of activations, with the same parameter obtained from the parameter memory 116.

By way of illustration, an example of multiplying different inputs with a corresponding parameter will be described with reference to one-dimensional (1D) data structures. However, this computational approach can also extend to a multi-dimensional computing context by, for example, performing a first set of computations using inputs obtained along a first dimension of an input tensor (e.g., an x-dimension) and, in parallel, performing a substantially similar second set of computations using inputs obtained along a second dimension of the input tensor (e.g., a y-dimension). This computational approach represents an example computing context that illustrates 2D parallelism, where a similar approach can be employed using respective sets of inputs obtained along each of an x, y, and z-dimension of the input tensor and which are then processed in parallel to illustrate 3D parallelism.

As indicated by FIG. 5, neural network computations that use a set of inputs to generate an example vector of output activations can include generating a respective partial sum for each input value in the set and accumulating the partial sums over several cycles to generate the vector of output activations. For example, given a 1D, 2D, or 3D vector of inputs, e.g., where at least one dimension has a size of 24 inputs, system 100 can compute a convolution using an example kernel size of 3 to generate the output activations. Using the techniques described in this document, system 100 can perform multiple computations in parallel to compute the convolution and can do so using a reduced number of processor cycles and with a higher overall utilization rate of its multipliers relative to conventional hardware circuits.

For example, system 100 can initialize a computation for a 1D input vector 402 with an input size of 12 (or 24). The system 100 can compute a convolution using a kernel size of 3, where the kernel comprises parameters k0, k1, and k2. In general, the 1D input vector 402 can include discrete input values that are each indicated by in[0], in[1], in[2], in[11]. Each vector entry, in[n], can represent a respective input, where n is an integer greater than or equal to zero. In some implementations, a subset of inputs (e.g., in[0], in[1], in[2], and in[3]) in the 1D vector can represent inputs of an example input window 302. In some cases, inputs of the input window 302 can correspond to pixels of a digital image obtained by an image sensor or correspond to other types of raw input data obtained by sensor devices that are external to system 100. As described in more detail below, system 100 can accelerate computing a convolution using, e.g., 1D, 2D, or 3D kernel, or a kernel of arbitrary sparseness, such as a kernel structure that has an arbitrary allocation of zero values in its data layout.

Diagram 500 illustrates an example of how the special-purpose hardware circuit of system 100 can extend parallelism with the multiple MACs of computation unit 112. For example, a computing block 202 of the computation unit 112 can include one or more sets of at least eight multipliers, where each of the eight multipliers in a set receives and stores the same parameter value, k0, k1, or k2. So, given a kernel size of 3, system 100 can be configured to obtain or load, from the activation memory 108, sets of 8 inputs or activations and multiply each of the 8 inputs in a set with a respective parameter to generate different sets of partial sums that can be accumulated over some number of cycles to generate a vector of output activations.

For example, at cycle=1, system 100 obtains 8 inputs 402 (an example 1-D basic tensor unit), in[0]—in[7], from activation memory 108 and uses multipliers 512 to multiply each input with the parameter, k0, to generate a set of partial sums 513. The obtained inputs 402 can be for a particular input window 302. At cycle=2 and for a stride=1 and skip=2, system 100 can obtain another set of 8 inputs, in[2]—in[9], from activation memory 108 and use the same set of multipliers to multiply each input with the parameter, k1, to generate a set of partial sums 515. A set of accumulators 516 receives the respective sets of partial sums 513 and 515, accumulates the partial sums 513 and 515, and generates a set of accumulated values 517 based on the accumulated partial sums. At cycle=3, system 100 can obtain another set of 8 inputs, in[4]—in[11], from activation memory 108 and use the same set of multipliers to multiply each input with the parameter, k2, to generate a set of partial sums 519. A set of accumulators 520 receives the set of accumulated values 517 and the set of partial sums 519, accumulates the values 517 with the partial sums 519, and generates the vector of output activations 522 based on the results of this accumulation. Accumulators 516 and 518 can represent a single set of accumulators that are reused each cycle to generate or compute accumulated values.

The output activations 522 may be stored at activation memory 108 and later obtained for loading at the MACs of computation unit 112, e.g., MACs that are used to perform computations using weights for another neural network layer. In general, system 100 stores data for the output activations 522 in the memory banks of activation memory 108 using specific bank assignment patterns.

In some implementations, the set of 8 inputs 402 may have been output activations that were previously stored after computations performed for another layer in the neural network. Output activations 522 may be obtained from activation memory 108 and used as inputs to another layer of a neural network in accordance with a stride or skip value for this other layer. For example, as indicated at FIG. 5, for the 8 multipliers of MACs 514, system 100 can load 8 values with skip=2. This is shown via data skipping visual 524, where input data in[0] is obtained at cycle=1 and the skip=2 causes input data in[2] to be at cycle=2. So, in each cycle, the system 100 obtains 8 inputs to compute a set of partial sums, and in a next cycle the system 100 obtains or reads the data by skipping some number of inputs or activations in accordance with a skip parameter for the neural network layer.

System 100 can include one or more groups of accumulators 516, 520 that are used to accumulate results data over one or more clock cycles. The result data can include respective sets of partial sums or accumulated values. In some implementations, groups of accumulators are: i) included, with multipliers 512, in a respective MAC of the computation unit 112; ii) formed from adder circuits that add two or more operands received from the sets of partial sums or accumulated values; and iii) used to normalize the addition results to generate an example vector of output activations.

In the preceding example, system 100 accumulated the multiple sets of results data over just three processor cycles. Hence, relative to the conventional hardware circuit, and using the multiple MACs of its processor hardware circuits, system 100 is configured to efficiently generate larger sets of partial sums that can be accumulated over a reduced number of processor cycles to accelerate generating the vector of output activations.

In some implementations, system 100 can compute a next set of outputs, e.g., out[8]—out[15], for an example 1D input size of 24 inputs (in[0] in[23]). For this implementation, system 100 might then load a next set of 8 inputs 526, in[8]—in[15], and use a particular set of MACs of computation unit 112 to multiply each input in the set with the parameter, k0. System 100 can continue this process of iterating through the 24 inputs of the 1D input window until the system reaches the end of the input window.

In some implementations, obtaining the example set of 8 inputs includes rotating the 8 inputs using the rotation unit 110 prior to loading the respective 8 inputs in each set to each cell of the MACs 512, 514, 518 at computation unit 112. MACs 512, 514, 518 correspond to the same MAC or, alternatively, may also correspond to different MACs. In other implementations, storing the output activations 522 includes using crossbar unit 114 to shuffle the memory address allocations for each output activation based on a bank assignment pattern generated using the control logic 106. As indicated above, the rotation unit 110 and crossbar unit 114 unit enable system 100 to obtain and store data for processing at neural network layer without bank conflict. In this manner, system 100 can achieve the efficiencies of parallelism and accelerated computations without the degraded performance that occurs from memory bank conflicts.

System 100 can obtain a set of inputs (i.e., basic tensor unit) every processor cycle, every other cycle, or based on a particular cycle iteration as defined by instructions processed by control logic 106. Similarly, the system 100 can vary the number of inputs that are obtained for a particular computation based on the instructions received by the control logic 106. In some implementations, system 100 extends its computations to 3D parallelism and may vary the number of inputs that are obtained for a particular computation such that an input tensor being processed is a multiple of bₓ×b_{y}×b_{z}. In this manner, the system 100 can be configured to achieve greater utilization of the MACs in computation unit 112 regardless of the stride value and/or skip value for a given neural network layer.

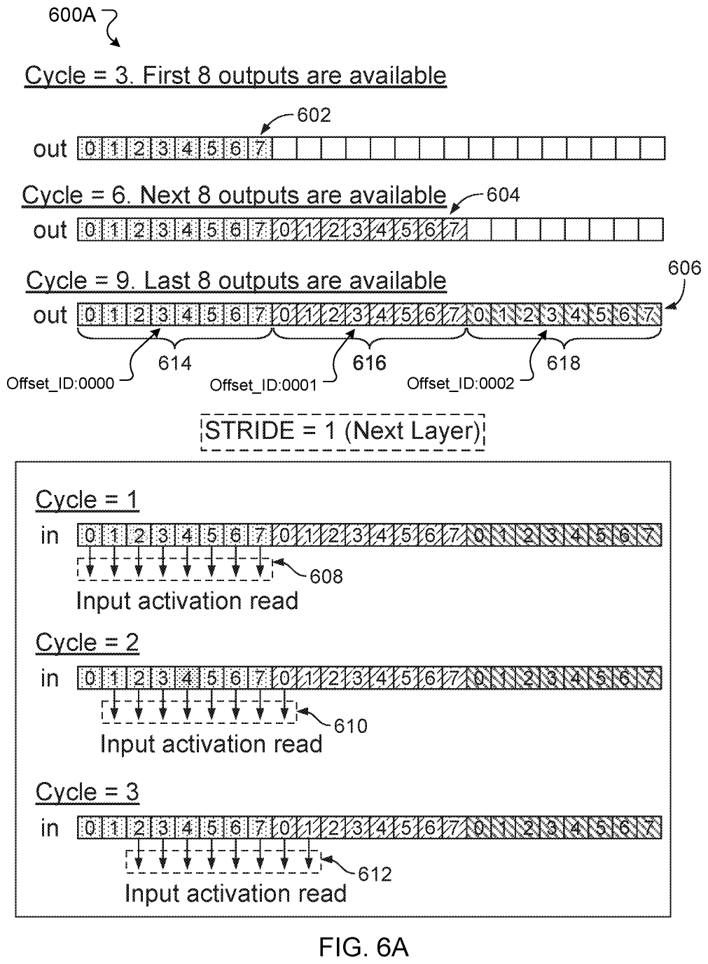

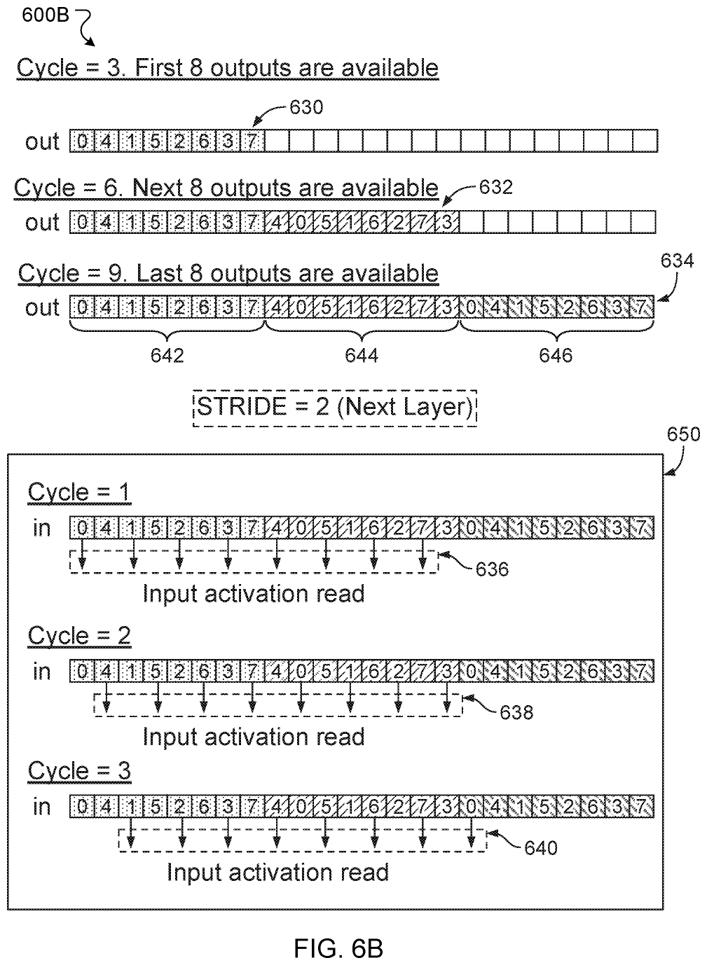

FIG. 6A shows an example diagram 600A that illustrates processing input data based on a stride value to perform a neural network computation. In general, at least two constraints can exist when configuring a system to support stride functions of a neural network layer. A first constraint is ensuring there is no memory bank conflict when the system writes or stores sets of output activations to memory. A second constraint is ensuring there is no memory bank conflict when the system reads or obtains the inputs or activations from the memory. As described herein, to address each constraint, the specialized hardware circuit of system 100 includes the crossbar unit 114 that causes data for output activations to be stored in the memory banks of activation memory 108. The crossbar unit 114 uses specific bank assignment patterns to prevent bank conflicts during storing and loading operations.

The following descriptions of FIG. 6A and FIG. 6B demonstrate how system 100 supports at least stride=1, for a next layer, and stride=2, for a next layer, respectively. The descriptions can be expanded to other stride parameters, e.g., stride=3 and higher, that may be assigned to a next layer that processes data for a given neural network computation. An example 1D computation is used for the description of FIG. 6A and 6B, for instance. Although a 1D example is used for illustration, the computing schemes associated with the implementation of FIG. 6A and 6B can be also extended to higher dimensions, such as 2D and higher. Further, the bank assignment patterns referenced in the description of FIG. 6A and 6B are examples used to illustrate how system 100 supports different stride values for the various layers of a neural network. Hence, one or more other bank assignment patterns can serve a given stride value and are within the scope of this disclosure.

In general, when computing a current layer, system 100 can use control logic 106 to determine a stride value for a next layer. For example, control logic 106 can reference programing instructions that define a stride value for a next layer in a set of computations for a neural network. The instructions may specify that stride=1, which means a stride of a next layer that receives inputs from activation memory 108 is equal to 1. As shown at FIG. 6A, when computing the current layer, system 100 can be configured to generate outputs in units of 8 consecutive output activations. In the above examples referencing FIG. 5, system 100 generates a set of output activations, out[0]—out[7], in the first 3 cycles using a kernel size of 3. In the next 3 cycles, system 100 generates another set of output activations, out[8]—out[15]. In the next 3 cycles, system 100 generates another set of output activations, out[16]—out[23].

System 100 can reference a stride value for a next layer when storing output activations generated for a current layer. For example, when the stride of the next layer is 1, system 100 can store the outputs of the current layer such that a first set of outputs 602 are stored in a first set of memory banks 614 (e.g., banks_0-banks_7), a second set of outputs 604 are stored in a second set of memory banks 616 (e.g., banks_0-banks_7), and a third set of outputs 606 are stored in a third set of memory banks 618 (e.g., banks_0-banks_7). In some implementations, each box in the sets of output activations 602, 604, 606 represents one output activation. The number, e.g., 0, 1, 2, 3, etc., in the box indicates what memory bank the data for the output activations is written to, or stored in.

For example, the first 8 output activations in the set 602 are written to memory banks of activation memory 108 in the order of bank 0, bank 1, bank 2, bank 3, bank 4, bank 5, bank 6, and bank 7. In some implementations, this write order is same for both the next 8 output activations in the set 604 and the last 8 output activations in the set 606. In other implementations, this write order can be different based on a particular bank assignment pattern that is generated using control logic 106 and based on the stride value for the next layer. The crossbar unit 114 processes the instructions for the bank assignment pattern to cause the sets of outputs 602, 604, 606 to be stored in the appropriate memory bank based on bank assignments specified in the instructions.

As mentioned above, the crossbar unit 114 uses specific bank assignment patterns to store the sets of outputs 602, 604, 606 at address locations of the memory banks in activation memory 108. Based on the bank assignment patterns, data for the sets of outputs are stored so there are no bank conflicts during the storing operations and so there are no bank conflicts during subsequent read operations to obtain data for inputs that correspond to the stored outputs.

In some implementations, system 100 is configured so that data for different sets of outputs that are stored in the same memory bank (e.g., bank_0) are stored, or sitting, at different offsets. When storing and/or retrieving input data from memory, an offset can be used to determine the address location in which the input data is stored. For example, system 100 may issue a data request to retrieve data starting at offset 8100. In general, an offset is an identifier, such as an offset ID number, that can be used to specify the correct location of data within a memory bank. Crossbar unit 114 uses offset values to identify the specific address location of a memory bank that stores a particular output.

In the implementation of FIG. 6A, data for each output in the respective sets 602, 604, 606 which are stored at the same memory bank (e.g., bank_1) are also stored at different offsets. For example, the data for the 8 output activations of set 602 are stored at offset 0, e.g., offset ID number 0000, of the 8 memory banks (bank_0-bank_7). The data for the 8 output activations of set 604 are stored at offset 1, e.g., offset ID number 0001, of the memory banks. Similarly, the data for the 8 output activations of set 606 are stored at offset 2, e.g., offset ID number 0002, of the memory banks.

System 100 reads or obtains input data from the memory banks of activation memory 108 (bank_0-bank_7) to perform computations for the next layer, where the next layer has a stride equal 1. In some implementations, the input data obtained from activation memory 108 corresponds to the output activations from the sets of outputs 602, 604, 606. The data reading process is shown at FIG. 6A for processor cycles 1, 2, and 3. As explained below, in the example of FIG. 6A, respective sets of input activations are obtained from memory banks of the activation memory 108 over three clock cycles. However, this process of reading, loading, or otherwise obtaining the data (e.g., activations) may occur over more than three processor cycles or fewer than three processor cycles.

In a first cycle, system 100 reads a set of inputs 608 (activations) from memory bank_0 to bank_7. In a second cycle, system 100 reads a set of inputs 610 that includes 7 activations from bank_1 to bank_7 and one activation from memory bank 0. As indicated at FIG. 6A, there is no bank conflict during these read operations performed by system 100. In a third cycle, system 100 loads or obtains a set of inputs 612 that includes 6 activations from bank_2 to bank_7) and two activations from memory bank_0 and bank_1). Again, there is no bank conflict for this read operation performed by system 100.

In the implementation of FIG. 6A, rotation unit 110 is used to rotate the input data after the activations are read from activation memory 108. For example, in cycle 1 for a computation that involves parameters k0, k1, and k2, the first activation among the 8 activations can be read from bank_0 and multiplied with parameter, k0. In cycle 2, the first activation among the 8 activations can be read from bank_1, multiplied with parameter, k1, and then accumulated with the result from the previous cycle, i.e., cycle 1. In this manner, system 100 may be required to route activations obtained from different memory banks to the same computation unit, e.g., a particular MAC that accesses the specific parameters k0 or k1. In some implementations, the input data obtained from the 8 different memory banks must be rotated (or shifted) so that system 100 provides the input data to the correct MAC of the computation unit 112.

FIG. 6B shows an example diagram 600B that illustrates processing input data based another stride value to perform a neural network computation. As discussed above, system 100 references a stride value for a next layer when storing output activations generated for a current layer. When the stride of the next layer is 2, system 100 can store the outputs of the current layer such that a first set of outputs 630 are stored in a first set of memory banks 642, a second set of outputs 632 are stored in a second set of memory banks 644, and a third set of outputs 634 are stored in a third set of memory banks 646. In this implementation, the crossbar unit 114 references the stride value of 2 for the next layer and, based on this stride value, generates a bank assignment pattern that causes data for the respective sets of outputs to be stored in certain memory banks of activation memory 108 such that no bank conflicts occur during the storing operation or a subsequent read operation to obtain the stored data.

For example, the 8 output activations in the set 630 are written to memory banks of activation memory 108 in the order of bank_0, bank_4, bank_1, bank_5, bank_2, bank_6, bank_3, and bank_7. The 8 output activations in the set 632 are written to memory banks of activation memory 108 in the order of bank_4, bank_0, bank_5, bank_1, bank_6, bank_2, bank_7, and bank_3. The 8 output activations in the set 634 are written to memory banks of activation memory 108 in an order that matches the order for the output activations in the set 630. In some implementations, the write order is different based on a particular bank assignment pattern that is generated using control logic 106 and based on the stride value for the next layer.

In the implementation of FIG. 6B, data for each output in the respective sets 630, 632, 634 which are stored at the same memory bank (e.g., bank_4) are also stored at different offsets of the memory banks. For example, the data for the 8 output activations of set 630 are stored at offset 0, the data for the 8 output activations of set 632 are stored at offset 1, and the data for the 8 output activations of set 634 are stored at offset 2. This example demonstrates the advantages of the crossbar unit 114 when storing or writing the output activations to activation memory 108. To support the different stride (or skip) parameters that may be assigned to a next layer, system 100 can be required to shuffle data for the outputs before storing the data in the memory banks of activation memory 108. This shuffling operation is enabled by the crossbar unit 114. To process inputs at a next layer that correspond to the stored output activations of a previous layer, system 100 reads the data for the previously stored output activations with stride=2 as shown diagram 650. As explained below, in the example of FIG. 6B, respective sets of input activations are obtained from memory banks of the activation memory 108 over three clock cycles. However, this process of reading, loading, or otherwise obtaining the data (e.g., activations) may occur over more than three processor cycles or fewer than three processor cycles.

The data reading process is shown at FIG. 6B for processor cycles 1, 2, and 3. In a first cycle, system 100 reads a set of inputs 636 (activations) from bank_0 to bank_7. In a second cycle, system 100 reads a set of inputs 638 from bank_4 to bank_7 and from bank_0 to bank_3. As indicated at FIG. 6B, there is no bank conflict during these read operations performed by system 100. In a third cycle, system 100 loads or obtains a set of inputs 640 from bank_1 to bank_7 and one input from memory bank_0. Again, there is no bank conflict for this read operations performed by system 100. In some implementations, system 100 uses a particular repeat pattern to support a certain stride value (e.g., stride=2) for a next layer, without any read bank conflicts or write bank conflicts.

In the implementation of FIG. 6B, rotation unit 110 can be used to rotate the input data after the activations are read from activation memory 108. For example, as indicated above, input data obtained from the different memory banks of activation memory 108 may need to be rotated (or shifted) so that system 100 provides the input data to a correct MAC of the computation unit 112.

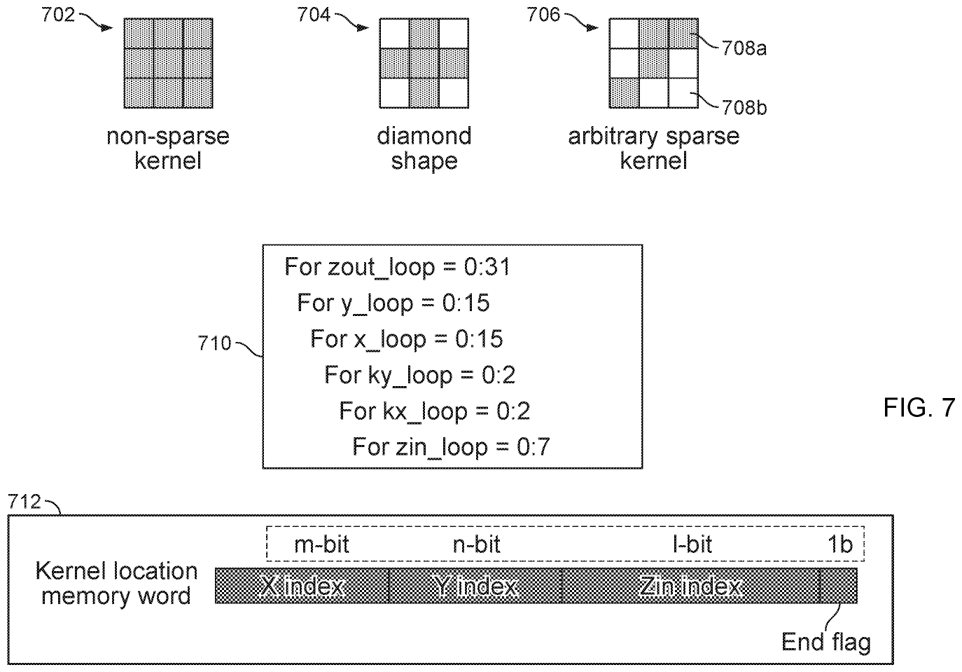

FIG. 7 shows diagrams that illustrate example kernel structures 702, 704, 706, a nested for loop 710, and an example memory word 712 for a kernel location memory. The kernel location memory is configured to store data representing one or more kernel structures (e.g., kernels 702, 704, 706). As described herein, core 102 can be configured to include a kernel location memory that enhances or increases flexibility of the core's control logic 106. The enhanced flexibility allows the system 100 and core 102 to efficiently process various types of kernel structures that may differ in their respective shapes and sparsity attributes. For example, core 102 can use the kernel location memory of control logic 106 to efficiently support different kinds of data sparseness in a kernel structure.

In general, a kernel location memory can be located at core 102, e.g., embedded at control logic 106. The kernel location memory enables system 100 to support various neural network computations that can involve arbitrarily shaped kernel structures. The shape of a kernel structure can be described with reference to the respective sparseness of the kernel structure. The sparseness of a kernel structure corresponds to the amount of individual zeros that are assigned to a respective element of a tensor that represents the kernel structure. For example, kernel structure 702 corresponds to a non-sparse kernel because the structure does not have zeros assigned to its elements. Kernel structure 704 corresponds to a diamond shaped kernel because the structure has zeros at its elements that cause the structure to have a shape that generally corresponds to a diamond. Kernel structure 706 corresponds to an arbitrary sparse kernel because zeros appear to be assigned arbitrarily to its elements. As shown at FIG. 7, kernel structure 706 can have a first data element 708a that has a non-zero value and a second data element 708b that has a zero value.

The kernel location memory of core 102 is configured to support arbitrary shapes over one or more spatial dimensions (x, y) of a kernel structure during an example neural network computation. In addition to the spatial dimensions, x, y, the kernel location memory of core 102 can also support sparsity in the zin direction. As discussed above, a zin, or depth, dimension can correspond to a third dimension of an input or activation volume and may represent respective color channels of an image.

In one instance, an example rectangular kernel having an arbitrary kernel shape can include multiple elements that are assigned zero values. Multiple zeros in a kernel structure or tensor can reduce the efficiency or hardware utilization of a system. The reduced efficiency and reduced hardware utilization occurs when the system loses processing cycles to load zero elements that do not include useful data for performing computations. As follows, this document describes techniques for using control functionality enabled by a kernel location memory to load only non-zero kernel components to computing cells of computation unit 112. The described techniques improves efficiency of the system because the system does not lose cycles loading zero kernel components. System 100 or other hardware can be used to train a neural network to have a particular spareness or sparse pattern(s). The training framework can construct an efficient network to exploit the sparsity supported by System 100.

Core 102 is configured to use a kernel location memory of control logic 106 to store non-zero kernel locations. In some implementations, the kernel location memory is a memory that is separate from activation memory 108. In some cases, system 100 uses an example storage medium, e.g., a random access memory, as a kernel location memory of each core 102 included at system 100. The following example is included to provide context for descriptions below relating to the kernel location memory. In one implementation, nested loops 710 are used by core 102 to process a set of inputs or input activations at an example convolution layer of a neural network. For example, a 3×3 kernel structure is applied to an input tensor of 16×16×8 input activations to generate an output tensor of 16×16×32 output activations. The for loop indices from x_loop and kx_loop loops are added to compute the x index of the 3D input tensor, the y_loop and ky_loop loops are added for the y index, and the zin_loop loop is for the z index. In this manner, the system 100 can iterate input tensor locations based on (x, y, z)=(x_loop+kx_loop, y_loop+ky_loop, zin_loop). In some implementations, this corresponds to the anchor point for the bₓ×b_{y}×b_{z} basic tensor unit discussed above where the anchor point refers to the activation at the origin of the basic tensor unit typically the activation at the top left corner in x and y positions at the first channel in z direction.

For an arbitrary shaped kernel, the system 100 is configured to replace the ky_loop, kx_loop, and zin_loop using data obtained from the kernel location memory. For example, a memory word 712 of the kernel location memory can have three data fields, where a particular field of the three fields indicates a respective x, y, or zin index. In some implementations, a fourth field in the memory word is used to indicate an end of a kernel computation for a given zin index. In some cases, the x and y indices can have a data size of m-bit and n-bit, respectively, and system 100 can be configured to support up to 2^{m}×2ⁿ kernel window based on this m-bit and n-bit data size. Likewise, system 100 can read a portion of data (e.g., 2, 4, or 6 zin's) for the zin index in a single cycle. A parameter value of the zin index can indicate the index of the zin portion of data that is being read. For example, a parameter value that translates to {zin index}=0 can indicate a portion of data that corresponds to zin element [0], or a parameter value that translates to {zin index}=1 can indicate a portion of data that corresponds to zin element [1]. In some cases, a zin index can have a data size of 1-bit and system 100 can be configured to support a particular zin index size based on this 1-bit data size. As indicated at FIG. 7, a memory word can include an end flag which indicates that the memory word corresponds to a last element of an index.

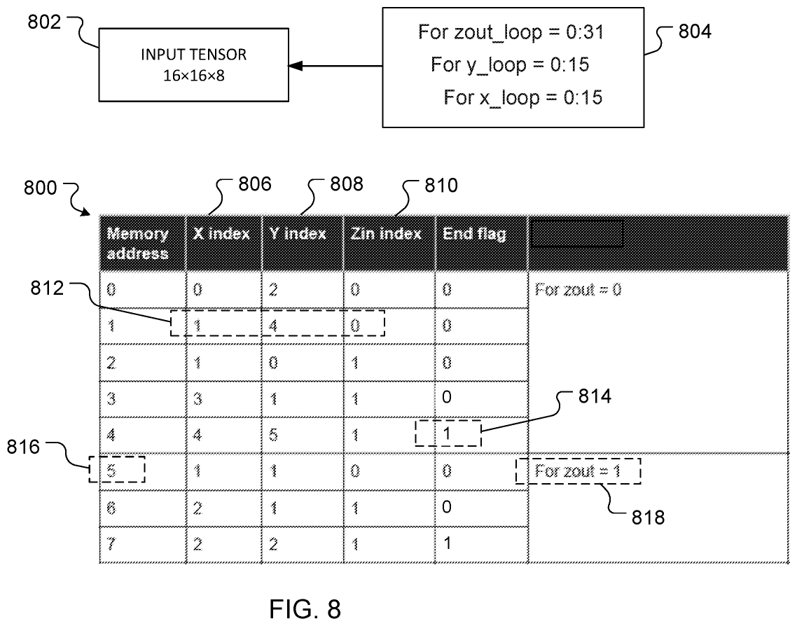

FIG. 8 shows an example data table 800 that includes information about memory addresses of a kernel location memory. For example, table 800 shows the data contents stored at memory address locations for the x index 806, y index 808, and zin index 810 of an example kernel. The data contents can be accessed and used to process an input tensor. In some implementations, system 100 is configured to identify indices for a parameter tensor stored at the parameter memory. The system can then add the identified indices to the (x, y, z) location of an input tensor stored at activation memory 108 to compute a final (x, y, z) location. For example, activations of a 16×16×8 input tensor 802 can be processed to generate output activations for a 16×16×32 output tensor. The core 102 can process the activations of the 16×16×8 input tensor 802 using nested loops 804.

When this processing operation begins, the core 102 can initialize nested loop 804 such that the zout_loop=0, y_loop=0, and x_loop=0. Using the described techniques, system 100 is configured to read memory address locations of the kernel location memory, e.g., one by one. For example, in a first cycle, the system causes core 102 to read a memory address for each of x index 806, y index 808, and zin index 810 to obtain data contents (0, 2, 0) from the kernel location memory. The obtained data for these indices of the kernel location memory is added to outputs of for loop 804 to compute a final (x, y, z) location that equals (0+0, 0+2, 0)=(0, 2, 0). A new basic tensor unit is read from the anchor location (0, 2, 0).

In a second cycle, the system 100 causes core 102 to read memory addresses to obtain data 812 (1, 4, 0), from the kernel location memory, for each of x index 806, y index 808, and zin index 810. In this instance, the system computes a final (x, y, z) based on (0+1, 0+4, 0) to obtain a result (1, 4, 0). The system 100 can perform a similar computation for a 3rd, 4th, or 5th cycle. In some implementations, the system 100 is configured to identify an occurrence of a parameter (e.g., end_flag) that is used to indicate that an end flag condition has been satisfied (e.g., end_flag=1). As indicated above, the occurrence of an end flag condition that is satisfied means a current memory word is the end of a process iteration involving the kernel location memory. For example, the end_flag parameter can be used to signal that a kernel location memory iteration is complete.

In some implementations, completion of a first kernel location memory iteration causes an increase with reference to a current position [element, index] of input tensor 802 that is being processed. In this manner, a current position value of input tensor 802 is increased for a next iteration of the kernel location memory. For example, the x_loop can be increased by an amount of stride which can correspond to (zout_loop, y_loop, x_loop)=(0, 0, 1), based on the input tensor 802. In this implementation, the system 100 begins reading a first position in a set of memory addresses of the kernel location memory to obtain data contents to perform similar computations as described above with reference to the first iteration. The system 100 applies this similar computation to compute a final set x, y, and z outputs, in response to reading the kernel location memory.

Processing of this second iteration can be substantially similar to the first iteration. For example, system 100 can identify an occurrence of an end flag parameter and read a value 814 of the end flag parameter to determine whether an end flag condition has been satisfied (e.g., end flag=1). The system can generate a signal to indicate that a kernel location memory iteration is complete, in response to determining that an end flag condition has been satisfied. When an iteration of the kernel location memory is complete, where the x_loop iterates from 0 to 15, the system can then increase a current position value of input tensor 802, which may correspond to (zout_loop, y_loop, x_loop)=(0, 1, 0). Completion of an iteration of the kernel location memory, where the y_loop iterates from 0 to 15, can cause an increase in a current position of input tensor 802 that triggers a change to a different zout, e.g., corresponding to (zout_loop, y_loop, x_loop)=(1, 0, 0). Hence, another iteration of the kernel location memory can begin reading from memory address 816 for zout=1 (818). In some implementations, system 100 includes zout monitoring logic that is configured to monitor a zout for loop to determine a current position value of the zout for loop and to detect an increase in a position value of the zout for loop.

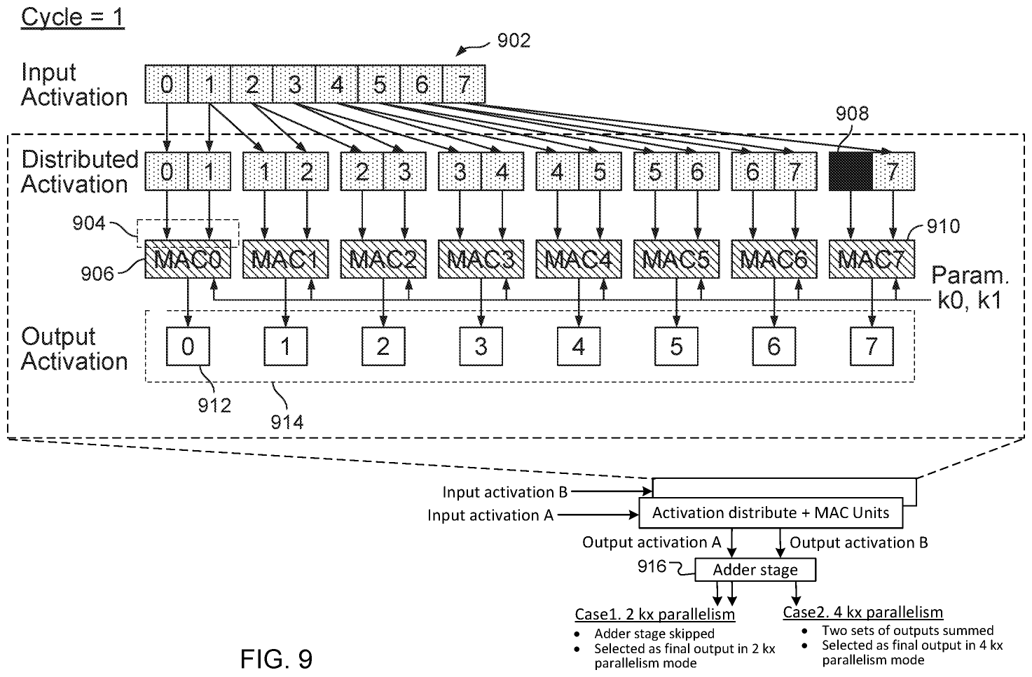

FIG. 9 shows an example diagram that illustrates parallelism that can be exploited when performing a depthwise neural network computation. As discussed in more detail below, parallelism can be described at least with reference to depthwise convolutions. In general, given an input tensor with multiple input channels, computations for depthwise convolutions can include: i) splitting the input tensor and a corresponding filter of parameters (e.g., k0, k1, k2) into channels; and ii) for each channel of the input tensor, convolving inputs for the channel with a corresponding filter parameter to produce a corresponding output. Multiple outputs can be pooled or concatenated to generate an output activation for an example output tensor. In general, depthwise convolutions that involve one or more input channels can yield output activations for one or more output channels of the output tensor.

As described above, an example input tensor may be a multi-dimensional (e.g., 3D) input tensor that can include a width, a height, and a depth of the input tensor. These dimensions can correspond respectively to an x-dimension, a y-dimension, and a zin dimension. The depth or zin dimension can correspond to a third dimension of an input or activation volume and can represent respective color channels of an image. In some implementations, when computing depthwise convolutions, a single activation in a given channel can be convolved with multiple parameters (kx and ky parallelism). In this manner, opportunities for exploiting parallelism features of system 100 can be leveraged, for example, to accelerate performing depthwise convolutions relative to the speed at which depthwise convolutions may be performed using conventional circuits. In some implementations, using the specialized processor hardware circuits of system 100, depthwise convolutions are accelerated while the system 100 also achieving relatively high utilization at computation unit 112, e.g., greater than 70% of MACs being utilized to perform computations.

System 100 is configured to leverage its parallelism features to support different computational schemes that may be used to perform computations at a multi-layer neural network. In some implementations, different types of parallelism may be leveraged depending on the parameters and instructions for a neural network computation that are received at core 102, e.g., from an external controller or host device. In some cases, various parallel computation opportunities may exist for certain convolution computations, such as a dense convolution. For example, in a dense convolution, system 100 can be configured to support a particular number of input channels (zin) and output channels (zout) for a set of activations based on a quantity of MACs that are available at computation unit 112. In some implementations, system 100 uses zin, zout, x, and y parallelisms for computations in dense convolution where the parallelism in a particular direction refers to multiple elements in that direction are computed in the same computation cycle, for example, 8x parallelism refers 8 elements in the x direction are computed simultaneously as in the computation example 500. System 100 is configured to support a-zin, b-zout, c-x, and d-y parallelisms which requires a ×b×c×d MAC units, where a, b, c, and d are integer values. For example, system 100 can be configured to support 8 zin, 8 zout, 6x, and 6y parallelisms which requires 8×8×6×6=2304 MAC units at computation unit 112.

In depthwise convolutions, however, an input channel can be used to generate multiple output channels. For example, a single input channel can be used to generate 1 output channel, 2 output channels, or 4 output channels. As described in more detail below, depthwise convolutions reduce opportunities for parallel computation because depthwise convolutions have less connections between the zin and zout dimensions resulting in inefficient zin and zout parallelism. This characteristic of depthwise convolutions can significantly reduce the MAC unit utilization in a computation unit, which causes inefficiencies in a processor circuit.

Among parallelism features supported by the processor hardware circuits of system 100, kx and ky parallelisms can offer opportunities to increase MAC unit utilization for computations associated with depthwise convolutions. In kx and ky parallelism, multiple parameters in the x and y directions are multiplied with activations simultaneously, c.f., a single parameter in x and y directions (k0, k1, and k2) are multiplied in a single cycle in dense convolution example 500. As described below, kx and ky parallelisms can be exercised in different zout-multiple cases, where “zout-multiple” refers to a number of output channels that are generated from a single input channel. For example, if one input channel generates two output channels, then for this computation the zout multiple=2.

Referring now to FIG. 9-FIG. 12, an example 1D computation is used to illustrate the kx parallelism using the kernel size=7, for instance. Although a 1D example is shown in the figures for illustration, this scheme for performing the 1D computation can be extended to higher dimensions, such as 2D and higher. In particular, the example 1D computation shows how inputs or activations are read for a particular cycle and how the 2 kx parallelism is exercised. For a given depthwise convolution, system 100 reads 8 activations 902 in a single cycle in an x-direction of the input structure. For example, in a first cycle, activations 902 at index in[0]-in[7] are read from activation memory 108. The activations 902 can be distributed over a particular number of MACs based on the computation instructions issued by control logic 106. For example, sets of two activations 904 can be distributed to at least one MAC 906 in a group of MACs that are used to perform the computation. Input 908 can represent an image pixel that has a zero value. As shown, input 0 and 1 is multiplied with parameter k0 and k1, respectively. The multiplication results are then accumulated to form an output activation 0 (912), e.g., a full or partial output activation. Likewise, input 1 and 2 is multiplied with parameter k0 and k1, respectively, and the multiplication results are then also accumulated to form a full or partial output activation 1. In MAC 910, input 7 may be multiplied with parameter k0 to form a partial output 7.

In some implementations, the 1-D example shown in FIG. 9 can be realized with MAC units, such as MAC 906, which has two multipliers and one accumulator, where the accumulator includes an adder circuit that adds partial sums accumulated over one or more processor cycles. Such implementations can be extended to two dimensions when MAC units such as MAC 906 include four multipliers (and one accumulator) for both the x-direction and the y-direction, where two multipliers enable kx parallelism and the other two multipliers enable ky parallelism. For this 1D example, just two multipliers are described because only the x-direction is referenced. As shown in FIG. 9, the set of two activations 904 in an x-direction of the 1D input structure is multiplied and accumulated for a single output, thereby representing a kx parallelism of 2.

In some implementations, computations similar to those occurring at cycle=1, may also occur for another window of inputs along the x-direction during a next processor cycle and using at least one of parameter k0, k1. In some cases, when read or used during a prior cycle, parameters, e.g., k1, can be stored in a temporary register that is later accessed to retrieve the parameter to perform a subsequent computation. For example, the register is accessed to obtain and feed k1 to a MAC 910 of computation unit 112 to generate a subsequent multiplication result. The multiplication results are accumulated to the output.

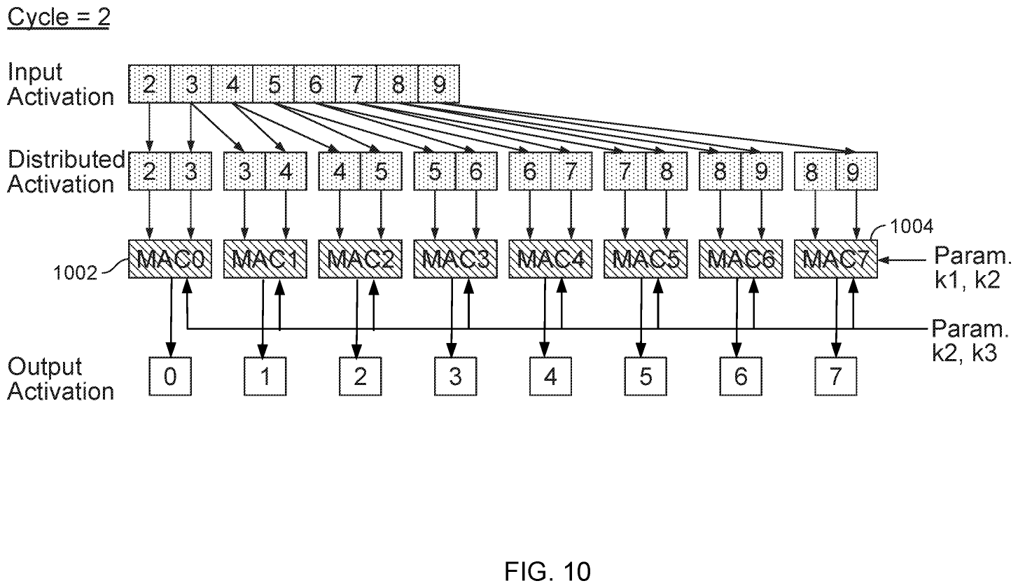

In a second cycle, activations at index in[2]-in[9] are loaded as shown in FIG. 10. Data for the first two activations, in[2] and in[3], are multiplied with k2 and k3, respectively, as indicated by MAC 1002, then accumulated to the result from the first cycle to generate a partial sum, in[0]*k0+in[1]*k1+in[2]*k2+in[3]*k3. At MAC 1004, however, data for activations in[8] and in[9] are multiplied with k1 and k2 where k1 is read from the previous cycle and stored in a temporary register to be used in cycle 2. A partial sum, in[7]*k0+in[8]*k1+in[9]*k2, is generated using MAC 1004.

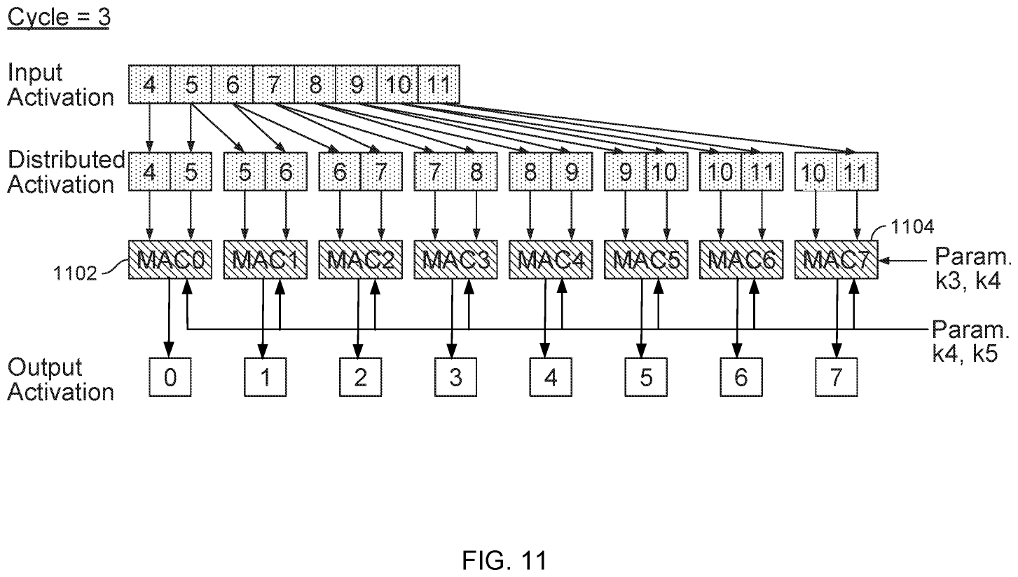

In the third cycle, as shown in FIG. 11, the same computation runs using different sets of data (in[4]-in[11]) and parameters (k4 and k5). In 1102, in[4] and in[5] are multiplied with k4 and k5, respectively, generating a partial sum, in[0]*k0+in[1]*k1+in[2]*k2+in[3]*k3+in[4]*k4+in[5]*k5. In 1104, the partial sum, in[7]*k0+in[8]*k1+in[9]*k2+in[10]*k3+in[11]*k4, is generated.

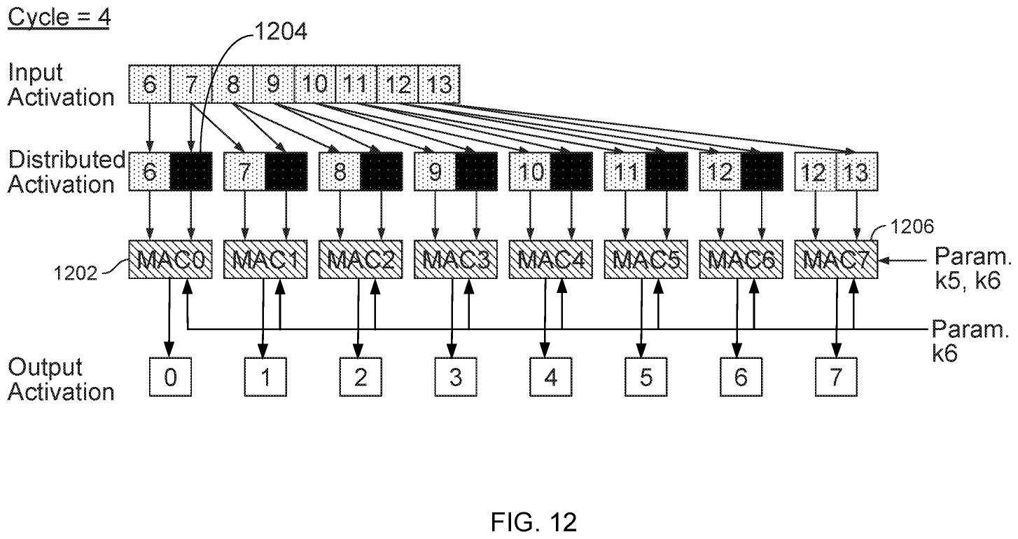

In the last cycle shown in FIG. 12, in[6] is multiplied with k6 in 1202 then accumulated resulting in the full sum, in[0]*k0+in[1]*k1+in[2]*k2+in[3]*k3+in[4]*k4+in[5]*k5+in[6]*k6. The 7 input data are multiplied with k0-k6 and accumulated to compute the kernel size of 7. The second input, 1204, is zero as the kernel size is 7. In 1206, two data are available for multiplication, in[12] and in[13], multiplied with k5 and k6, respectively. The full sum generated by 1206 is in[7]*k0+in[8]*k1+in[9]*k2+in[10]*k3+in[11]*k4+in[12]*k5+in[13]*k6 which also multiplies 7 data with k0-k6 and accumulates to compute the kernel size of 7. In some implementations, the control of the operation in the above example can be orchestrated by the control logic 106 to distribute and feed activations and parameters to the MAC units. In some implementations, the system 100 can use different sets of MAC units using the same activations but different parameter sets to support zout multiple where one input channel generates multiple output channels.

In general, system 100 can support a variety of different kx-ky parallelism mechanisms and even multiple different kx-ky parallelism mechanisms can be supported in a single hardware circuit. Although FIG. 9-FIG. 12 show data and parameter distribution patterns for 2 kx parallelism, similar distribution schemes can support 4 kx parallelism and configurable distribution logic can be used to support multiple different kx-ky parallelism mechanisms. For the sake of this discussion, the following types of configurations can be considered: i) 2×2 kx-ky parallelism with zout multiple equaling 4; ii) 4×4 kx-ky parallelism with zout multiple equaling 1; and iii) 4×2 kx-ky parallelism with zout multiple equaling 2. For kx-ky configuration iii), this can be implemented as either kx parallelism=4 and ky parallelism=2 or kx parallelism=2 and ky parallelism=4.

Typically, depthwise convolution kernels have fewer connections between the input channels to the output channels, thereby reducing the amount of zin and zout parallelism that can be exploited. System 100 can overcome this reduction in parallelism by exploiting parallelism in the kernel x and y direction, i.e., kx-ky parallelism. In addition, the exact extent of kx-ky parallelism can be chosen in such a manner that the utilization of multipliers is maximized in both dense convolutions as well as depthwise convolutions.

In some implementations, for 4×4 kx-ky parallelism, system 100 may still require the same number of total multipliers in 2×2 kx-ky parallelism. For example, twice as many multipliers may be required to cover 4 kx parallelism relative to the number of multipliers that are required to cover 2 kx parallelism. This is the same for ky parallelism in the y direction, which requires 4 times more multipliers in total, but this requirement can negated because, as indicated above, the zout multiplier=1 for 4×4 kx-ky parallelism whereas zout multiplier=4 for 2×2 kx-ky parallelism. In some implementations, 4×4 kx-ky parallelism requires additional adders to generate the output activations 914 from intermediate partial sums. However, the additional adder stage can be skipped in 2×2 kx-ky parallelism.

Referring again to FIG. 9, in this 1D example, there are two “activation distribute+MAC unit” modules to support both 2 kx and 4 kx parallelism. In a 2D example, four such modules are needed to support 2×2, 2×4, 4×2, and 4×4 kx-ky parallelism. An adder stage 916 receives two sets of output activations, namely, output activations A and output activations B. In this example, each set of output activations contains 8 output activations. For a first case involving 2 kx parallelism, the adder stage 916 is skipped. At the output, there are 2 sets of output activations that are selected as the final outputs in 2 kx parallelism mode. For a second case involving 4 kx parallelism, the adder stage 916 sums up the two sets of output activations resulting in one set of output activations that is selected as the final output in 4 kx parallelism mode.

In some implementations, the architecture can employ a configurable logic to rearrange the input activations and/or parameters depending on the operation mode such as dense convolution, depthwise convolution in 2×2 kx-ky parallelism, depthwise convolution in 2×4 kx-ky parallelism, depthwise convolution in 4×2 kx-ky parallelism, and depthwise convolution in 4×4 kx-ky parallelism. In some implementations, the architecture can employ a configurable logic to rearrange the output activations depending on the operation mode.

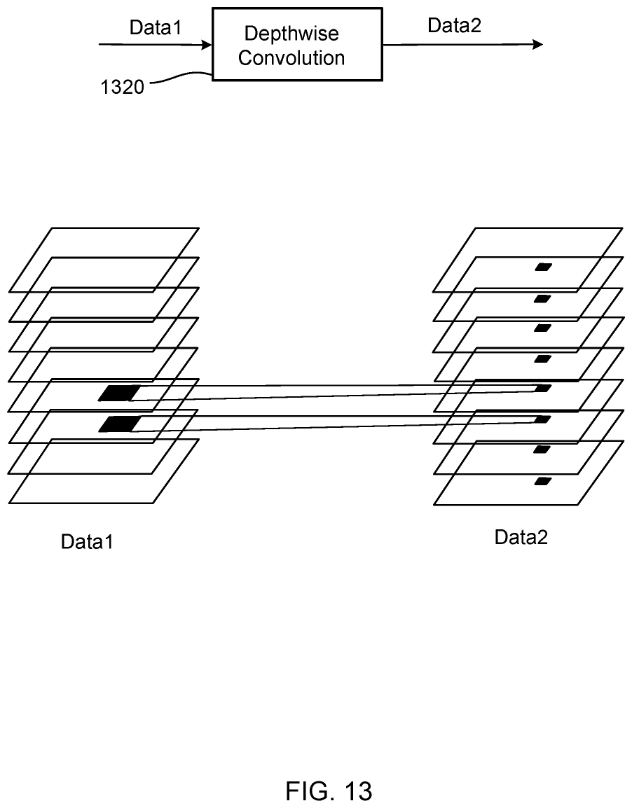

FIG. 13 shows an example diagram that illustrates a depthwise convolution layer 1320 when zout multiple=1. In some implementations, kernels for each input channel can use different parameters, but have the same shape, e.g., 3×3, or 7×7. In some implementations, normal dense convolutions can use a 4D weight tensor, whereas depthwise convolutions may only use a 3D weight tensor.

In general, a depthwise convolution can be sparse (e.g., very sparse) compared to normal dense convolutions. This is because a number of connections is divided by a number of channels. Conventional circuits that heavily leverage parallelism in input and output activation channels cannot achieve high utilization of their computation units when performing depthwise convolutions. This is because a ratio of computation involving input and output channels to memory bandwidth is much lower for depthwise convolutions than for typical dense convolutions. However, the routing from the rotation unit 110 to the MACs in the computation unit 112 of the special-purpose hardware circuits of system 100 can be configured to achieve utilization rates that are higher than the rates observed with conventional hardware circuits. In some implementations, the improved utilization can be achieved by changing the connectivity patterns of inputs and weights to MACs of computation unit 112. This may require a configurable logic to change the routing scheme depending on the operation modes, such as dense convolution and depthwise convolution.

By utilizing the configurable logic to support flexible connectivity patterns, system 100 can achieve high utilization rates both in dense and depthwise convolutions. For example, a depthwise convolution has fewer links between channels (e.g., input or output channels), i.e., a single input channel is used to generate multiple output channels. On the other hand, a dense convolution uses multiple input channels to generate multiple output channels. The core 102 may be configured to exploit the parallelism opportunity within the spatial kernels in depthwise convolution. In this manner, system 100 can achieve the high utilization using configurable connectivity logic by treating, e.g., bz-zin data in a bₓ×b_{y}×b_{z} basic input tensor as part of the spatial dimension.

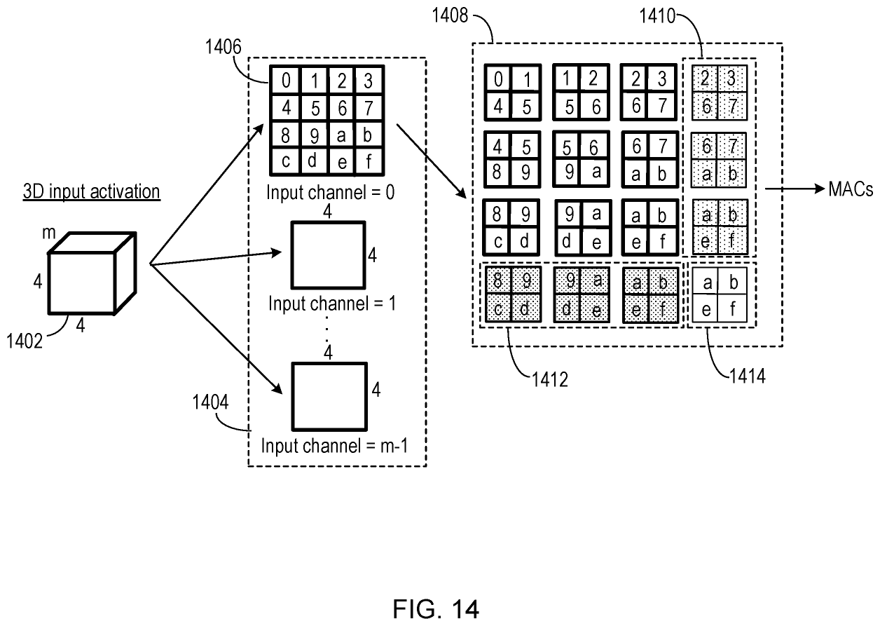

This configuration can be obtained using the example scheme in FIG. 14 illustrating 4×4×bz example basic input tensor supporting 2×2 kx-ky parallelism. The reference to a 4×4 data size for the x and y spatial dimensions of the input tensor are examples used to describe how system 100 supports kx-ky parallelism. Other data sizes for the x and y dimensions are within the scope of this description.

The 4×4×b_{z} input activation 1402 can be sliced into b_{z} 4×4×1 activations 1404. This example shows how the first input channel 1406 is distributed and fed to the MAC units and all other channels are also distributed in the same way. For 2×2 kx-ky parallelism, the 4×4×1 input activation 1406 is divided into multiple 2×2 pieces 1408 where each 2×2 piece represents an input window and each element in a 2×2 window is the neighboring data in the 4×4×1 window 1406. In some implementations, one or more 2×2 windows at the edges 1410, 1412, and 1414 are redundant to support last pixel window as in 908. These 2×2 windows can require the same data as its neighboring 2×2 window, but some of the data can be masked or zero'd out as described above. In the implementation of FIG. 14, input windows 1410 show the redundant windows that can be required for 2 kx parallelism and input windows 1412 are the redundant windows for 2 ky parallelism. Input window 1414 is the redundant window for 2×2 kx-ky parallelism. In 4×4 and 2×4 (4×2) kx-ky parallelism, different distribution patterns can be used to support a given kx-ky parallelism.

When 4×4 kx-ky parallelism is used, this computing scheme can involve doing, for example, a 5×5 convolution in 4 cycles. Using the special-purpose hardware circuit of system 100, this computing scheme can be configured to achieve an improved percent utilization of MAC clusters in an example computation unit when compared to conventional circuits. For example, the computing scheme can achieve greater than 70% MAC unit utilization at computation unit 112 depending at least on the kernel size, zout-multiple, and kx-ky parallelism. In some implementations, this first computing scheme may still require additional computations to perform a full reduction of partial sums.

System 100 can compute 4 simultaneous (i.e., zout multiple=4), for example, 5×5 depthwise convolutions using 2×2 kx-ky parallelism in 9 cycles with improved percent utilization of the MACs at computation unit 112. In this second computing scheme, the output channels can correspond to the same 2×2 block as the input channel, across 4 outputs that belong to 4 separate depthwise convolutions. This second computing scheme can provide substantially higher utilization rates and avoids the need for a reduction step.

System 100 can also compute 2 simultaneous (i.e., zout multiple=2), for example, 5×5 depthwise convolutions using 2×4 kx-ky parallelism in 6 cycles with improved percent utilization of the MACs at computation unit 112.

In some implementations, results of a first part of the computation that was described with reference to FIG. 13 can be written to address locations of activation memory 108, e.g., across multiple memory banks, using bank assignment patterns processed using crossbar unit 114. In some cases, to enable reading from the multiple memory banks in parallel, crossbar unit 114 can process instructions that define different x-dimension and y-dimension permutations.

What is claimed is:

1. A circuit for performing computations for a neural network comprising a plurality of neural network layers, the circuit comprising:
a processing device configured to process data signals and provide programming data for performing the computations; and
a core in data communication with the processing device to receive the programming data provided by the processing device, wherein the core comprises:
an activation memory configured to store sets of layer inputs;
a parameter memory configured to store parameters for a first neural network layer;
a rotation unit configured to rotate accessing the sets of layer inputs from the activation memory based on the programming data;
a computation unit having multiple computing cells, at least one computing cell of the multiple computing cells being configured to:
i) receive, for the first neural network layer, an input of the sets of layer inputs accessed by the rotation unit,
ii) receive a parameter for the first neural network layer, and
iii) generate at least a portion of an output of the first neural network layer using the input and the parameter; and
a crossbar unit configured to cause the output of the first neural network layer to be stored, in the activation memory, in accordance with a bank assignment pattern that is based on the programming data and an attribute value assigned to a second neural network layer.

2. The circuit of claim 1, wherein the rotation unit is further configured to rotate elements of an input tensor, where each element of the input tensor corresponds to a respective input of a set of inputs stored in the activation memory.

3. The circuit of claim 2, wherein the rotation unit is further configured to:
rotate elements of the input tensor along a first dimension of the input tensor based on a first rotation factor;
rotate elements of the input tensor along a different second dimension of the input tensor based on a second rotation factor that is different than the first rotation factor; and
provide an input that corresponds to a rotated element of the input tensor to a computing cell of the computation unit.

4. The circuit of claim 1, wherein the crossbar unit is further configured to:
determine a mapping of activations in the output in response to processing the bank assignment pattern, where the mapping identifies memory banks of the activation memory for storing the activations for the second neural network layer based on the attribute value assigned to the second neural network layer.

5. The circuit of claim 4, wherein the crossbar unit is further configured to:
cause data for the output of the first neural network layer to be stored at particular address locations of the activation memory, the data for the output being assigned to an address location of the activation memory based on a configurable mapping that changes for different respective layers of the neural network.

6. The circuit of claim 4, wherein:
the rotation unit is further configured to access output data for the output of the first neural network layer as layer inputs to the second neural network layer for processing at the second neural network layer; and
the determined mapping is configured such that a bank conflict does not occur at the memory banks of the activation memory when the rotation unit accesses layer inputs for the second neural network layer that correspond to the output of the first neural network layer.

7. The circuit of claim 1, wherein the attribute value assigned to the second neural network layer is:
a stride value for the second neural network layer, or
a skip value for the second neural network layer.

8. The circuit of claim 1, wherein the core is configured to:
use the rotation unit to access layer inputs stored in a first set of memory banks of the activation memory without the occurrence of a bank conflict; and
use the crossbar unit to store layer outputs in a second set of memory banks of the activation memory without the occurrence of a bank conflict.

9. The circuit of claim 7, wherein the core is configured to:
synchronize rotation based data access operations of the rotation unit with pattern based data storage operations of the crossbar unit to achieve a utilization rate of the computation unit that exceeds a threshold utilization rate.

10. The circuit of claim 1, wherein the processing device is configured to:
receive, from an external controller, an instruction comprising data values to be used at the core; and
provide at least the data values of the instruction to the core for storing at a component of the core.

11. The circuit of claim 10, wherein the processing device is a digital signal processor (DSP) configured to:
process an instruction received from the external controller; and
in response to processing the instruction, configure one or more registers at the core using data values of the instruction.

12. The circuit of claim 11, wherein the core is configured to access the one or more registers to obtain configuration data that defines the computations for the neural network, the computations being performed by the computation unit of the core based on data values derived from the instructions received from the external controller.

13. A computer-implemented method for performing computations for a neural network comprising a plurality of neural network layers, the method comprising:
providing, by a processing device of a hardware circuit, programming data for performing the computations for the neural network;
receiving, by a core of the hardware circuit that communicates with the processing device, the programming data provided by the processing device, wherein the core comprises an activation memory configured to store sets of layer inputs and a parameter memory configured to store parameters for a first neural network layer;
accessing, by a rotation unit of the core, the sets of layer inputs stored at the activation memory, wherein the rotation unit rotates accessing the sets of layer inputs based on the programming data received by the core;
receiving, by a computation unit of the core, an input of the sets of layer inputs accessed by the rotation unit, the input being received for processing at the first neural network layer;
receiving, by the computation unit, a parameter for the first neural network layer;
generating, by the computation unit, an output of the first neural network layer using the input accessed by the rotation unit and the parameter; and
storing, using a crossbar unit of the core, the output of the first neural network layer in the activation memory in accordance with a bank assignment pattern that is based on the programming data and an attribute value assigned to a second neural network layer.

14. The method of claim 13, further comprising:
rotating, by the rotation unit, elements of an input tensor, where each element of the input tensor corresponds to a respective input of a set of inputs stored in the activation memory.

15. The method of claim 14, further comprising:
rotating, by the rotation unit, elements of the input tensor along a first dimension of the input tensor based on a first rotation factor;
rotating, by the rotation unit, elements of the input tensor along a different second dimension of the input tensor based on a second rotation factor that is different than the first rotation factor; and
providing, by the rotation unit, an input that corresponds to a rotated element of the input tensor to a computing cell of the computation unit.

16. The method of claim 13, further comprising:
determining, by the crossbar unit, a mapping of activations in the output in response to processing the bank assignment pattern, where the mapping identifies memory banks of the activation memory for storing the activations for the second neural network layer based on the attribute value assigned to the second neural network layer.

17. The method of claim 16, further comprising:
assigning, using the crossbar unit, data for the output of the first neural network layer to an address location of the activation memory based on a configurable mapping that changes for different respective layers of the neural network; and
storing, using the crossbar unit, the data for the output of the first neural network layer at particular assigned address locations of the activation memory based on the configurable mapping for the second neural network layer.

18. The method of claim 16, wherein:
the rotation unit is further configured to access output data for the output of the first neural network layer as layer inputs to the second neural network layer for processing at the second neural network layer; and
the determined mapping is configured such that a bank conflict does not occur at the memory banks of the activation memory when the rotation unit accesses layer inputs for the second neural network layer that correspond to the output of the first neural network layer.

19. The method of claim 13, further comprising:
assigning a stride value for the second neural network layer that corresponds to the attribute value; or
assigning a skip value for the second neural network layer that corresponds to the attribute value.

20. The method of claim 13, further comprising:
using, by the core, the rotation unit to access layer inputs stored in a first set of memory banks of the activation memory without the occurrence of a bank conflict; and
using, by the core, the crossbar unit to store layer outputs in a second set of memory banks of the activation memory without the occurrence of a bank conflict.

21. The method of claim 20, further comprising:
synchronizing, by the core, rotation based data access operations of the rotation unit with pattern based data storage operations of the crossbar unit to achieve a utilization rate of the computation unit that exceeds a threshold utilization rate.

22. The method of claim 13, further comprising:
receiving, by the processing device and from an external controller, an instruction comprising data values to be used at the core; and
providing, by the processing device, at least the data values of the instruction to the core for storing at a component of the core.

23. The method of claim 22, wherein the processing device is a digital signal processor (DSP) and the method further comprises:
processing, by the DSP, an instruction received from the external controller; and
in response to processing the instruction, configuring, by the DSP, one or more registers at the core using data values of the instruction.

24. The method of claim 23, further comprising:
accessing, by the core, the configured one or more registers to obtain configuration data that defines the computations for the neural network; and
performing, at the computation unit, the computations based on data values derived from the instructions received from the external controller.

25. One or more non-transitory machine-readable storage devices for storing instructions that are executable by one or more processing devices to cause performance of operations comprising:
providing, by a processing device of a hardware circuit, programming data for performing the computations for the neural network;
receiving, by a core of the hardware circuit that communicates with the processing device, the programming data provided by the processing device, wherein the core comprises an activation memory configured to store sets of layer inputs and a parameter memory configured to store parameters for a first neural network layer;
accessing, by a rotation unit of the core, the sets of layer inputs stored at the activation memory, wherein the rotation unit rotates accessing the sets of layer inputs based on the programming data received by the core;
receiving, by a computation unit of the core, an input of the sets of layer inputs accessed by the rotation unit, the input being received for processing at the first neural network layer;
receiving, by the computation unit, a parameter for the first neural network layer;
generating, by the computation unit, an output of the first neural network layer using the input accessed by the rotation unit and the parameter; and
storing, using a crossbar unit of the core, the output of the first neural network layer in the activation memory in accordance with a bank assignment pattern that is based on the programming data and an attribute value assigned to a second neural network layer.
